(19) United States
(12) Patent Application Publication
(10) Pub. No.: US 2019/0287339 A1
(43) Pub. Date: Sep. 19, 2019

(54) METHODS, DEVICES AND SYSTEMS UTILIZING VIRTUAL CURRENCIES IN REGULATED CASINO GAMES

(71) Applicant: SYNERGY BLUE, LLC, Palm Springs, CA (US)

(72) Inventor: Michael M. OBERBERGER, Spring Hill, TN (US)

(21) Appl. No.: 15/922,171

(22) Filed: Mar. 15, 2018

(51) Int. Cl. G07F 17/32

(52) U.S. Cl. CPC G07F 17/3244; G07F 17/3209; G07F 17/3262; G07F 17/3288; G07F 17/3241; G07F 17/3213; G07F 17/3239

(57) ABSTRACT

A computer-implemented method of determining a reward due to a player of a regulated gaming machine may comprise accepting money from a player; rendering a computer-generated landscape on a display; disposing a corresponding plurality of landmarks at respective locations, within the computer-generated landscape, at least one of the plurality of landmarks being a wager-enabled landmark that is configured to initiate a wager; generating a virtual avatar for the player and placing the virtual avatar within the computer-generated landscape; accepting, via a user interface, input from the player to move the generated virtual avatar within the computer-generated landscape; debiting some of the money accepted from the player for each unit of movement of the virtual avatar within the computer-generated landscape; and when inputs are received from the player that cause the virtual avatar to move within the computer-generated landscape to a wager-enabled landmark and that cause the virtual avatar to interact with an in-game asset located at the wager-enabled landmark, initiating the wager and randomly determining the reward due to the player.

### BACKGROUND

Embodiments shown and described herein are directed to methods, devices systems, and computer program products for utilizing virtual currencies in wager-based games in regulated casino games.

### BRIEF DESCRIPTION OF THE DRAWINGS

FIG. 1 illustrates a block diagram of a gaming network suitable for implementing embodiments.

FIG. 2 shows a block diagram of an electronic gaming system according to one embodiment.

FIG. 3 illustrates a network diagram of gaming network that may be configured to implement embodiments described herein.

FIG. 4 is a block diagram of electronic gaming device, according to an embodiment.

FIG. 5 is a block diagram of an intelligent electronic gaming system, according to one embodiment.

FIG. 6 is a block diagram of a mobile gaming device with which an embodiment may be practiced.

FIG. 7 shows a system server suitable for implementing various aspects of embodiments described herein.

FIG. 8 shows a functional block diagram of a gaming system server according to one embodiment.

FIG. 9 shows a block diagram illustrating components of a gaming system suitable for implementing an embodiment.

FIG. 10 is a representation of aspects of a game according to one embodiment, showing the computer-generated landscape and several landmarks within the game.

FIG. 11 is another representation of aspects of a game according to one embodiment, showing the computer-generated landscape and several other landmarks within the game.

FIGS. 12 is a flowchart of a computer-implemented method according to one embodiment.

FIG. 13 shows a wager-based regulated gaming machine configured according to embodiments. FIG. 13 also shows exemplary tangible, non-transitory computer-readable media having data stored thereon representing sequences of instructions which, when executed by the regulated gaming computing device, cause the regulated gaming computing device to determine rewards due to a player playing a wager-based game according to embodiments.

### DETAILED DESCRIPTION

Veteran gamblers (e.g., older gambler demographic age 50+) have been accustomed to a standard set of video gaming symbols (e.g., A, J, K, Q from playing cards) which, for example, may be accompanied with a multitude of additional themed symbols (e.g., fruits, animals, fantasy creatures, media personas, etc.) presented on a series of wheels or drums. Newer technology has made possible the use of digital display screens that present the reels and symbols in a digital format. Such existing slot machine technology, however, is dated and may be unappealing to younger players. Indeed, younger gamblers (e.g., also referred to as “gamers”), on the other hand, are accustomed to home gaming consoles (Nintendo, XBOX, PlayStation and the like) that provide them with exquisitely-rendered immersive 2D & 3D game environments with which they can interact. These gamers, who are used to fast paced, energetic, and visually stunning games, feel that the display method of the traditional slot machines are unappealing, which leads to decreased revenue for casino operators.

It is desirable, therefore, to offer hybrid arcade/wager-based games or gambling arcade games that provide hybrid arcade-style, wager-based gaming techniques, which find a ready demographic in younger gamers. However, one significant obstacle regarding such hybrid arcade-style, wager-based gaming techniques is that they often rely on complex back end solutions that require lengthy and costly processes of regulatory review and approvals in many different gaming jurisdictions.

One possible workaround to this significant obstacle is to configure/design a hybrid arcade-style, wager-based game such that it is compliant with currently approved wager-based gaming regulatory standards such as, for example, the well-known GLI standards, which have already been approved in various gaming jurisdictions. One example of a GLI standard is the GLI-11 standard version 3.0, Published Sep. 21, 2016 by Gaming Laboratories International, LLC, which is incorporated herein by reference.

For example, in one embodiment, a hybrid arcade-style, wager-based game may be configured to provide an arcade-style gaming interface which enables a player to participate in an arcade-style game at the wager-based gaming machine. One or more events and/or activities performed by the player (e.g., during play of the arcade-style game) may automatically trigger a random number generator (RNG)-based wager that is compliant with applicable gaming standards, rules and regulations. Because such wager-based activities comply with currently existing GLI standard(s) (and/or other national, regional, local gaming rules and regulations), such hybrid arcade-style, wager-based games may not require additional regulatory approval for deployment in casino venues.

In one embodiment, a hybrid arcade-style, wager-based game may be created by combining a new and different visual game representation with a new and different method of player interaction. The hybrid arcade-style, wager-based game may be configured to provide a perceptually stimulating experience using a wide variety of human interface devices (HID), based on the theme/style of the gambling game at hand. For example, some games may utilize a gun controller for first person shooter games, or steering wheels, accelerator and brake pedals for driving games. These and other types of games and interactions may be adapted for hybrid arcade/wager-based gaming.

For example, the format of the hybrid arcade-style, wager-based game may also focus on other types of video and/or arcade-style games such as, for example, non-linear (e.g., open world) type video and/or arcade-style games such as, for example, Grand Theft Auto, linear type video and/or arcade-style games such as, for example, Half-Life, massively multiplayer online “MMO” type video and/or arcade-style games such as, for example, World of Warcraft, role-playing game “RPG” type video and/or arcade-style games such as, for example, Final Fantasy, and/or others, Such games may feature a player character that may be moved through the game world via player input, (e.g., HID), which allows for an increased sense of excitement through gameplay by providing a multitude of player-choice possibilities through a wide-array of path directions.

In some embodiments, the format of the hybrid arcade-style, wager-based game may facilitate a gameplay environment in which multiplayer functionality takes place. The multiplayer gameplay may have multiple “enrollment” aspects in which one, for example, particular player could be on location at a casino playing a hybrid arcade/wager-based game, while another (e.g., different) player could be at a different location, concurrently participating in the same hybrid arcade/wager-based game, but without participating in any wagering aspect/portions of hybrid arcade/wager-based game. A non-wagering game such as this is commonly known as a “free to play” game, which the player is allowed to download and install on their own devices. The player may then progress through the game (e.g., which is very similar to its the wager based counter-part) without taking part in wager-based events. Gaming situations such as these may promote a “clicks to bricks” outcome where a casino property promotes their games to home users, and invites them to develop familiarity and expertise on non-wagering versions of the games. Later, those same home players may be invited to visit the casinos to play the hybrid arcade/wager version of the games.

In some embodiments, different players concurrently participating in the same hybrid arcade/wager-based game may each separately configure his/her respective wagering parameters/amounts, which may be different from the wagering parameters/amounts configured by other game player-participants.

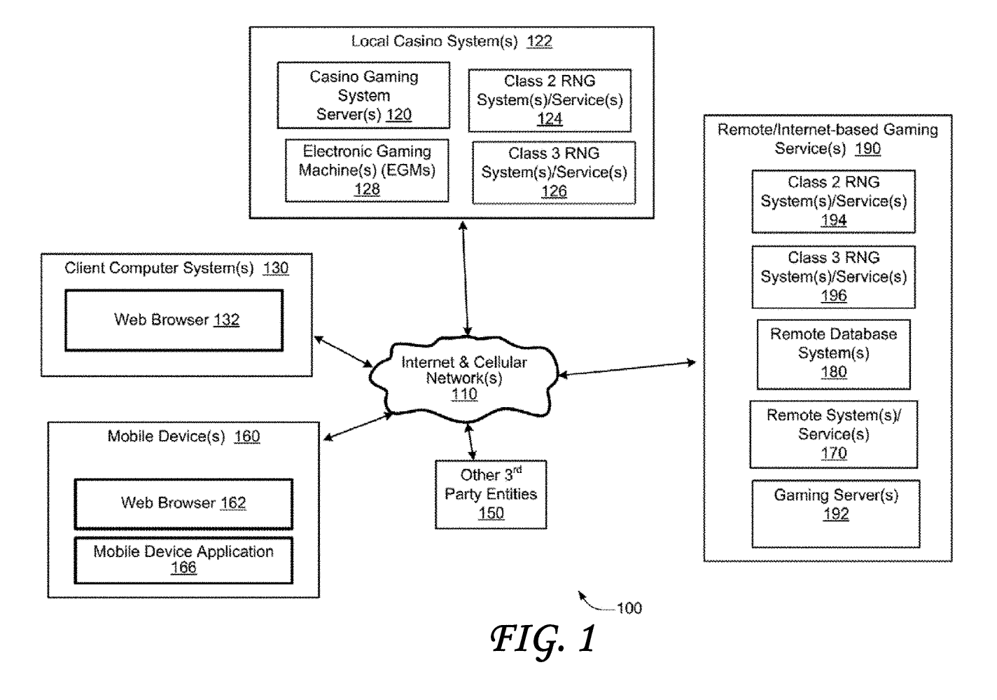

FIG. 1 illustrates a block diagram of an embodiment of a hybrid arcade/wager-based gaming system 100 which may be implemented via a computer network. At least a portion of the various functions, actions, operations, and activities performed by one or more component(s) of the hybrid arcade/wager-based gaming system may be initiated in response to detection of one or more conditions, events, and/or other criteria satisfying one or more different types of minimum threshold criteria. According to embodiments, at least a portion of the various types of functions, operations, actions, and/or other features provided by the hybrid arcade/wager-based gaming system may be implemented at one or more client systems(s), at one or more system server(s), and/or combinations thereof. According to different embodiments, the present hybrid arcade/wager-based gaming system 100 may be implemented in hardware and/or combinations of hardware and software.

According to one embodiment, a hybrid arcade/wager-based gaming system 100 may include local casino system(s) 122, client computer systems 130, mobile devices 160 and remote/Internet-based gaming services 190 and other 3^{rd} party entities 150, coupled to a computer/communication network 110. The local casino system(s) 122 may include local casino gaming system server(s) 120. The local casino system(s) 122 may also include and class 2 RNG system(s)/service(s) 124. The Class 2 RNG system(s)/service(s) 124 may be configured to dynamically generate and/or provide Class 2 gaming type RNG outcomes to be used by hybrid arcade/wager-based Gaming devices as “predetermined” RNG outcome(s). Class 3 RNG system(s)/service(s) 126 may also be provided to dynamically generate and provide Class 3 gaming “predetermined” RNG outcome(s). Local casino system(s) 122 may also include electronic gaming machine(s) (EGMs) 128 that may be configured as described herein below.

Client computer system(s) 130 may also be operable to couple to the network 110 and implement various types of functions, operations, actions, and/or other features such as those described or referenced herein via, for example, a web browser 132. Similarly, mobile computing devices 160 (e.g., mobile phones, tablets and the like) may be configured to access the network 110 and to use a mobile web browser 162 and/or one or more mobile applications (apps) 166 to implement some or all of the functionality described herein. Third party entities 150 may also be configured to carry out some or all of the functionality described herein via the network 110.

Remote/Internet-based gaming service(s) 190 may also be coupled to network 110 and may comprise class 2 RNG system(s)/service(s) 194 as described relative to reference numeral 124, class 3 RNG system(s)/service(s) 196 as described relative to reference numeral 126, and remote database system(s) 180. Remote system(s)/service(s) 170 may be provided, which may include, for example, content provider servers/services, media streaming servers/services, database storage/access/query servers/services, financial transaction servers/services, payment gateway servers/services, electronic commerce servers/services, event management/scheduling servers/services and/or other services as needed. Remote/Internet-based gaming service(s) 190 may also include gaming servers 192.

According to embodiments, multiple instances or threads of hybrid arcade/wager-based gaming may be concurrently implemented and/or initiated via the use of one or more processors and/or other combinations of hardware and/or hardware and software. Embodiments may access and/or utilize information from one or more associated databases via communication with one or more local and/or remote memory devices.

According to different embodiments, various different types of encryption/decryption techniques may be used to facilitate secure communications over the network 110 and/or via other communication channels. For example, such encryption may utilize random number generators, SHA-1 (e.g., Secured Hashing Algorithm), MD2, MD5, DES (e.g., Digital Encryption Standard), 3DES (e.g., Triple DES), RC4 (e.g., Rivest Cipher), ARC4 (e.g., related to RC4), TKIP (e.g., Temporal Key Integrity Protocol, uses RC4), AES (e.g., Advanced Encryption Standard), RSA, DSA, DH, NTRU, and ECC (e.g., elliptic curve cryptography), PKA (e.g., Private Key Authentication), Device-Unique Secret Key and other cryptographic key data, SSL and/or others. Other security features may include use of well-known hardware-based and/or software-based security components, and/or any other known or yet to be devised security and/or hardware and encryption/decryption processes implemented in hardware and/or software.

Embodiments of hybrid arcade/wager-based gaming described herein may be implemented in hardware and/or a combination of both hardware and software. Possible implementations include in an operating system kernel, in a separate user process, in a library package bound into network applications, on a specially constructed machine, or on a network interface card. In a specific embodiment, various aspects described herein may be implemented in software such as an operating system or in an application running on an operating system.

Alternatively, hardware and/or software embodiments of present hybrid arcade/wager-based gaming techniques described herein may be implemented on a general-purpose programmable computer selectively activated or reconfigured by a computer program stored in memory. Such programmable machine may include, for example, mobile or handheld computing systems, PDA, smart phones, notebook computers, tablets, netbooks, desktop computing systems, system servers, cloud computing systems, network devices, etc.

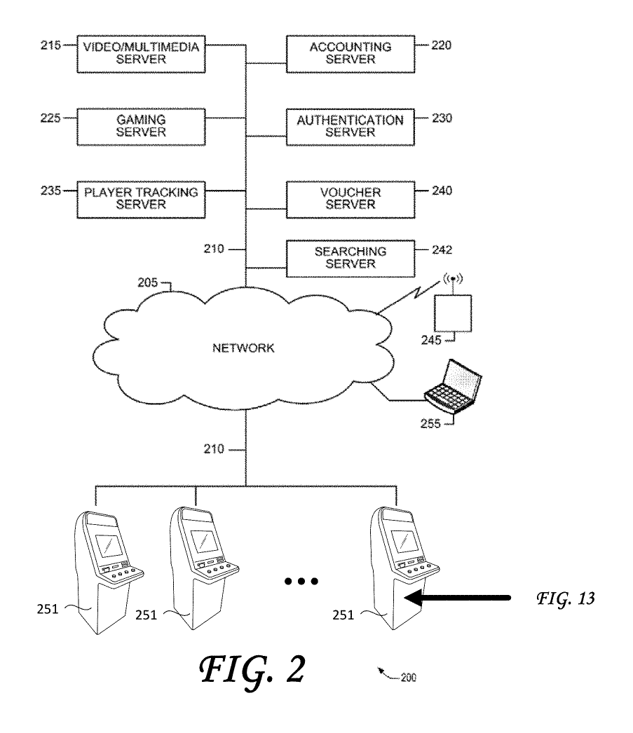

FIG. 2 shows an example block diagram of an electronic gaming system 200 according to one embodiment. As shown, electronic gaming system 200 may include electronic gaming devices (EGD) 251 (e.g., electronic gaming terminals, electronic gaming machines, wager-based video gaming machines, etc.), which may be coupled to network 205 via a network link 210. Network 205 may include the internet and/or a private network. One or more video streams may be received at video/multimedia server 215 from EGDs 251. Video/multimedia server 215 may also send one or more video streams to mobile devices 245, 255, EGDs 251, and/or other remote electronic devices. Video/multimedia server 215 may send these video streams via network link 210 and network 205.

Electronic gaming system 200 may include an accounting/transaction server 220, a gaming server 225, an authentication server 230, a player tracking server 235, a voucher server 240, and a searching server 242. The accounting/transaction server 220 may compile, track, store, and/or monitor cash flows, voucher transactions, winning vouchers, losing vouchers, and/or other transaction data for the casino operator and for the players. Transaction data may include the number of wagers, the size of these wagers, the date and time for these wagers, the identity of the players making these wagers, and the frequency of the wagers. Accounting/transaction server 220 may also generate tax information relating to these wagers, generate profit/loss and/or other reports for predetermined gaming options, contingent gaming options, predetermined betting structures, and/or outcome categories. Gaming server 225 may generate gaming options based on predetermined betting structures and/or outcome categories. These gaming options may be predetermined gaming options, contingent gaming options, and/or any other gaming option disclosed herein. The authentication server 230 may determine the validity of vouchers, players' identity, and/or an outcome for a gaming event. The player tracking server 235 may track a player's betting activity, a player's preferences such as the player's preferred language, drinks, font, sound level, and the like. Based on data obtained by player tracking server 235, a player may be eligible for gaming rewards (e.g., free play), promotions, and/or other awards (e.g., complimentary food, drinks, lodging, concerts, etc.). Voucher server 240 may generate a voucher, which may include data relating to gaming options. The generated vouchers may be physical (e.g., paper) or digital.

Searching server 242 may implement a search on one or more gaming devices to obtain gaming data. Searching server 242 may implement a messaging function, which may transmit a message to a third party (e.g., a player) relating to a search, a search status update, a game status update, a wager status update, a confirmation of a wager, a confirmation of a money transfer, and/or any other data relating to the player's account. The message can take the form of a text display on the gaming device, a pop up window, a text message, an email, a voice message, a video message and the like. Searching server 242 may implement a wagering function, which may be an automatic wagering mechanism. These functions of searching server 242 may be integrated into one or more servers. Searching server 242 may be configured to, for example, determine which games paid out the most money during a time period, which games kept the most money from players during a time period, which games are most popular (e.g., top games), which games are least popular, which games have the most amount of money wager during a period, which games have the highest wager volume, which games are more volatile (e.g., volatility, or deviation from the statistical norms, of wager volume, wager amount, pay out, etc.) during a time period, and the like. Search may also be associated with location queries, time queries, and/or people queries.

According to embodiments, the gaming network 300 may include a display system server(s) 304 configured manage content (e.g., graphics, images, text, video fees, etc.) to be displayed and/or presented at one or more EGDs, dealer displays, administrator displays, etc. One or more EGD multimedia system server(s) 305 may be provided and coupled to network 310 and configured to manage content (e.g., graphics, images, text, video fees, audio feeds, etc.), which, for example, is to be streamed or provided to one or more EGDs (e.g., or to one or more groups of EGDs). One or more messaging system server(s) 306 may be provided and coupled to network 310 and configured for the management of messaging and/or other communications among and between the various systems, components, devices, EGDs, players, dealers, and administrators of the gaming network. mobile system server(s) 308 may manage communications and/or data exchanged with various types of mobile devices such as player-managed mobile devices (e.g., smart phones, PDAs, tablets, mobile computers), casino-managed mobile devices (e.g., mobile gaming devices). financial system server(s) 312 may be configured to track, manage, report and store financial data and financial transactions relating to one or more hybrid arcade/wager-based game sessions. According to one embodiment, a player tracking system server 314 may include at least one database that tracks each player's hands, wins/losses, bet amounts, player preferences, etc., in the network. In one implementation, the presenting and/or awarding of promotions, bonuses, rewards, achievements, etc., may be based on a player's play patterns, time, games selected, bet amount for each game type, etc. A player tracking system server may also help establish a player's preferences, which assists the casino in their promotional efforts to: award player comps (e.g., loyalty points); decide which promotion(s) are appropriate; generate bonuses and the like. Data tracking & analysis system(s) 318 may be configured to manage and analyze game data. In one embodiment, the data tracking & analysis system(s) may be configured to aggregate multisite hybrid arcade/wager-based gaming trends, local wins and jackpots.

Gaming system server(s) 322, 324 may each be dedicated to one or more specifically designated type(s) of game(s). Each game server may include game logic to host one of more virtual hybrid arcade/wager-based game sessions. At least some game server(s) may also be configured to track of the game accounting (e.g., money in, money out) for a virtual hybrid arcade/wager-based game being played, and/or for updating the financial system servers 312 at the end of each game. The game server(s) 322, 324 may also configured to generate the EGD graphics primitives (e.g., game virtual objects and game states), and may further be operable to update EGDs when a game state change (e.g., new card dealt, player upped the ante, player folds/busts, etc.) is detected. Jurisdictional/regulatory monitoring & enforcement system(s) 350 may be configured to handle tracking, monitoring, reporting, and enforcement of specific regulatory requirements relating to wager-based gameplay activities in one or more jurisdictions.

Authentication & validation system(s) 352 may be configured to determine and/or authenticate the identity of the current player at a given EGD. For example, in one embodiment, the current player may be required to perform a log in process at the EGD in order to access one or more features. Alternatively, the EGD may be adapted to automatically determine the identity of the current player based upon one or more external signals such as, for example, scanning of a barcode of a player tracking card, an RFID tag or badge worn by the current player which provides a wireless signal to the EGD for determining the identity of the current player. In at least one implementation, various security features may be incorporated into the EGD to prevent unauthorized players from engaging in certain types of activities at the EGD. In some embodiments, the authentication & validation system(s) 352 may be configured to authenticate and/or validate various types of hardware and/or software components, such as, for example, hardware/software components residing at a remote EGDs, game play information, wager information, player information and/or identity, etc.

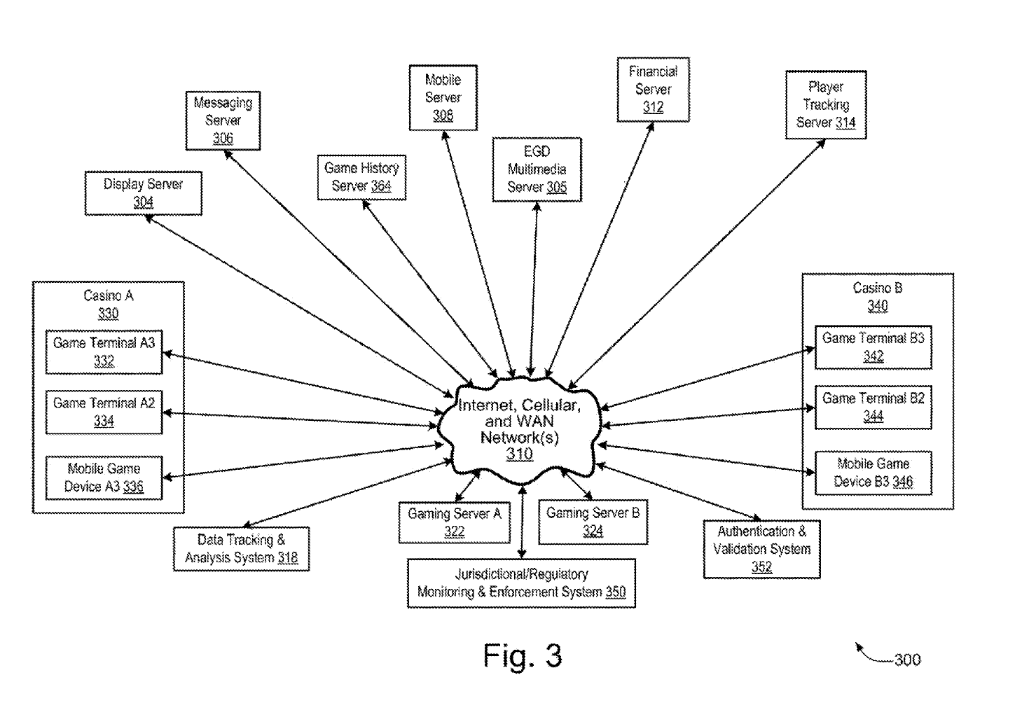

Casino venues, shown in FIG. 3 as Casino A 330 and Casino B 340, may correspond to a real-world, physical casino located at a particular geographic location. In some embodiments, a portion of the multiple different casino venues may be affiliated with one another (e.g., Harrah's Las Vegas, Harrah's London). In other embodiments, at least a portion of the multiple different casino venues do not share any affiliation with each other.

EGDs 332, 334, 336, 342, 344, 346 may be configured to enable players to participate in game sessions according to embodiments. Different EGDs may be physically located in one or more different casino venues, and may be connected via a communication network such as shown at 310 in FIG. 3, which may include Internet, Cellular, and WAN Network(s). In some embodiments, EGDs may be implemented as stationary machines. In some embodiments, at least some EGDs may be implemented using mobile devices (e.g., tablets, smartphones, laptops, PC's, and the like).

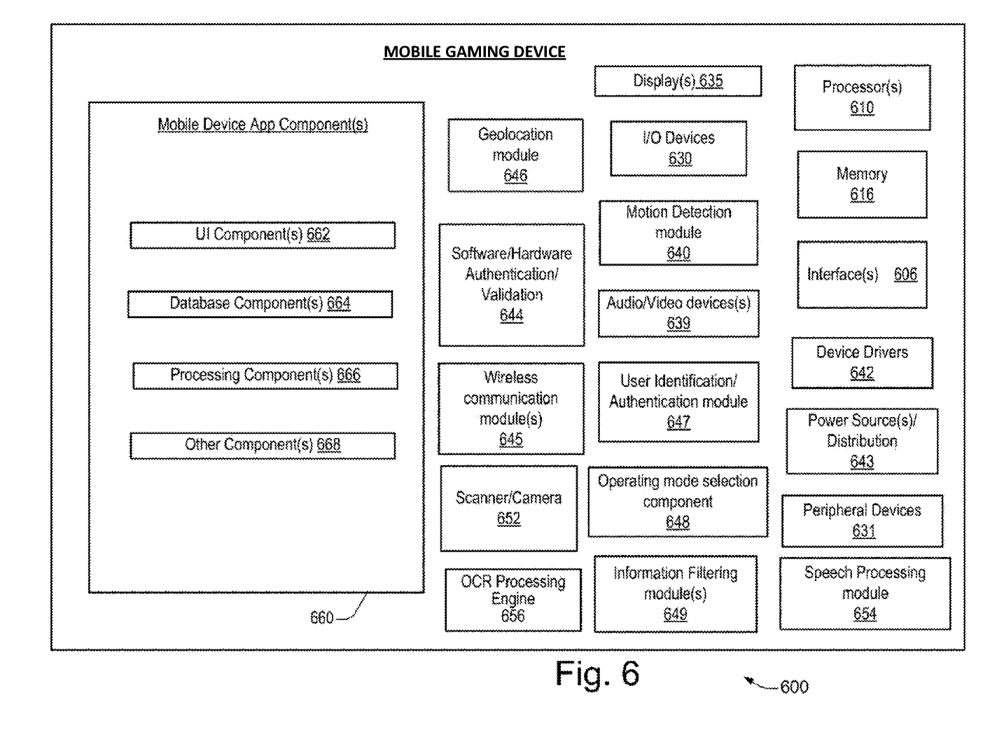

Game history server(s) 364 may be provided. Game history servers 364 may be configured to track game types and game play history for hybrid arcade/wager-based games. In some embodiments, a game history server may also assist the casino manager in case of disputes between players and the casino by, for example, providing the ability to “replay” (e.g., by virtually recreating the game events) the game in dispute, step by step, based on previously stored game states. Remote database system(s) may be coupled to network 310 and selectively accessible and may be configured to store and provide access to various types of information and data described herein. Remote system server(s)/service(s) may be provided, and configured to provide, for example, content provider servers/services media streaming servers/services database storage/access/query servers/services, financial transaction servers/services, payment gateway servers/services, electronic commerce servers/services, event management/scheduling servers/services and/or other services. Mobile Game Device(s) 336, 346 may be configured to provide the services described below relative to FIG. 6.

According to specific embodiments, a variety of different game states may be used to characterize the state of current and/or past events which are occurring (e.g., or have occurred) at a given EGD. For example, in one embodiment, at any given time in a game, a valid current game state may be used to characterize the state of game play (e.g., and/or other related events, such as, for example, mode of operation of the EGD, etc.) at that particular time. In at least one embodiment, multiple different states may be used to characterize different states or events which occur at the EGD at any given time. In one embodiment, when faced with ambiguity of game state, a single state embodiment forces a decision such that one valid current game state is chosen. In a multiple state embodiment, multiple possible game states may exist simultaneously at any given time in a game, and at the end of the game or at any point in the middle of the game, the EGD may analyze the different game states and select one of them based on certain criteria. Thus, for example, when faced with ambiguity of game state, the multiple state embodiment(s) allow all potential game states to exist and move forward, thus deferring the decision of choosing one game state to a later point in the game. The multiple game state embodiment(s) may also be more effective in handling ambiguous data or game state scenarios.

A variety of different entities may be used (e.g., either singly or in combination) to track the progress of game states which occur at a given gaming EGD. Examples of such entities may include a master controller system, display system, gaming system, local game tracking component(s), remote game tracking component(s), etc. Examples of various game tracking components may include, but are not limited to: automated sensors, manually operated sensors, video cameras, intelligent playing card shoes, RFID readers/writers, RFID tagged chips, objects displaying machine readable code/patterns, etc.

Local game tracking components at the EGD may be operable to automatically monitor game play activities at the EGD, and/or to automatically identify key events which may trigger a transition of game state from one state to another as a game progresses. Depending upon the type of game being played at the gaming table, examples of possible key events may include the start of a new gaming session; the end of a current gaming session; the start of a virtual slot wheel spin; a game start event; a game end event; the detection of an event that triggers the initiation of wager-based event (e.g., killing a zombie, carrying out a predetermined action upon encountering a Wagering Opportunity, and the like); the detection of event that triggers the end of a wager-based event; the detection of event that triggers the initiation or end of a randomized game play event; an initial wager period start or end; a subsequent wager period start or end; or a payout period start or end.

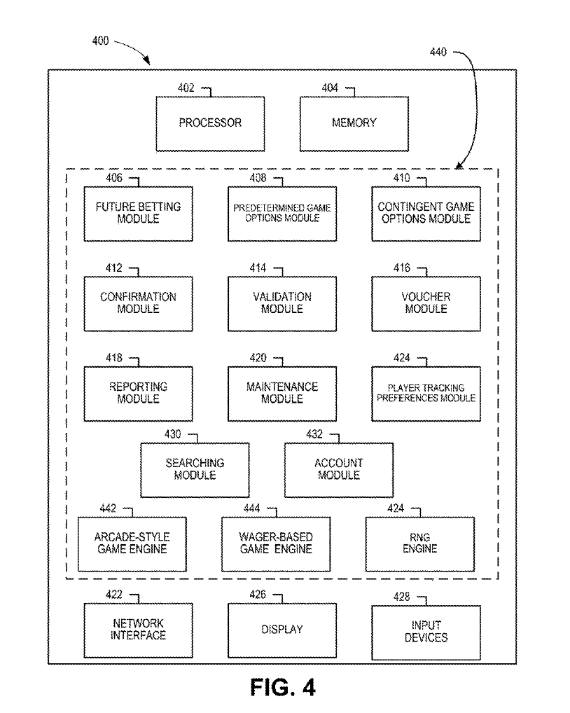

FIG. 4 shows a block diagram 400 of electronic gaming device 400 according to one embodiment. As shown, electronic gaming device 400 may include a processor 402, a memory 404, a network interface 422, input devices 428, and a display 426. Processor 402 may generate gaming options based on predetermined betting structures and/or outcome categories. Predetermined betting structures may utilize more than one outcome category to generate via processor 402 gaming options. Predetermined betting structures may combine any outcome category with any other outcome category to gaming options. The processor 402 may offer a gaming option that is structured so that the gaming option relates to more than one EGD. Processor 402 may generate contingent gaming options and/or predetermined gaming options. Contingent gaming options 410 may be structures configured such that a wager is activated when a triggering event occurs.

Network interface 422 may be configured to enable the electronic gaming device 400 to communicate with remote devices/systems such as, for example, video/multimedia server(s), accounting/transaction server(s), gaming server(s), authentication server(s), player tracking server(s), voucher server(s) over a communication network, such as shown at 110, 205 and 310. Input devices 428 may be or include mechanical buttons, electronic buttons, one or more touchscreens, microphones, cameras, optical scanners, or any combination thereof. Input devices 428 may be utilized to make a wager, to make an offer to buy or sell a voucher, to determine a voucher's worth, to cash in a voucher, to modify (e.g., change sound level, configuration, font, language, etc.) electronic gaming device 400, to select a movie or music, to select type of content to be displayed on main and/or auxiliary screen(s) of EGD, or any combination thereof.

Arcade-style game engine 442 may be configured to manage the arcade-style game play portion (or entertainment portion) of the hybrid arcade/wager-based game. In contrast, a wager-based game engine 444 may be configured to manage the wager-based game event portion(s) of games according to embodiments. A Random Number Generator (RNG) Engine 446 may be provided and may include software and/or hardware algorithm and/or processes which are used to generate random outcomes, and may be used by the wager-based game engine to generate wager-based game event outcomes.

Display 426 may show video streams from one or more gaming devices, gaming objects from one or more gaming devices, computer generated graphics, predetermined gaming options, and/or contingent gaming options. The memory 404 may include various memory modules 440, including a future betting module 406, a predetermined game options module 408, a contingent game options module 410, a confirmation module 412, a validation module 414, a voucher module 416, a reporting module 418, a maintenance module 420, a player tracking preferences module 424, a searching module 430, and an account module 432.

Future betting module 406 may store data relating to the predetermined betting structure. Processor 402 may utilize data in future betting module 406 to generate predetermined gaming options and/or contingent gaming options. Any other processor (e.g., gaming server 225, any virtualized gaming server, etc.) may implement the functions of processor 402. Predetermined game options module 408 may store data relating to predetermined gaming options, which may be offered to a player. The contingent game options module 410 may store data relating to contingent gaming options, which may be offered to a player. The confirmation module 412 may utilize data received from a voucher, the transaction history of the voucher (e.g., in the case in which the voucher changed hands in a secondary market), and/or the identity of the player to confirm the value of the voucher. In another example, confirmation module 412 may utilize game event data, along with voucher data to confirm the value of the voucher. A validation module 414 may utilize data received from a voucher to confirm the validity of the voucher. Voucher module 416 may store data relating to generated vouchers, redeemed vouchers, bought vouchers, and/or sold vouchers. Reporting module 418 may generate reports related to a performance of electronic gaming device 400, electronic gaming system(s), hybrid arcade/wager-based game(s), video streams, gaming objects, credit device(s) or identification device(s), for example.

In one implementation, reporting module 418 may reside on a central server and may be configured to aggregate and generate real time statistics on betting activities at one or more hybrid arcade/wager-based games at one or more participating casinos. The aggregate betting statistics may include trends (e.g., aggregate daily wager volume and wager amount by game types, by casinos, and the like), top games with the most payouts, top tables with the most payouts, top search structures used by players, most popular hybrid arcade/wager-based game(s) by wager volume, most searched for game, hybrid arcade/wager-based game(s) with least payouts, weekly trends, monthly trends, and other statistics related to game plays, wagers, people, location, and searches.

Maintenance module 420 may track any maintenance that is implemented on electronic gaming device 400 and/or electronic gaming system 200. Maintenance module 420 may schedule preventative maintenance and/or request a service call based on a device error. The player tracking preferences module 424 may compile and track data associated with a player's preferences.

Searching module 430 may include one or more searching structures, one or more searching algorithms, and/or any other searching mechanisms. In one example, the search may end once one or more triggering events are determined. In another example, the search may end once data has been received from a predetermined number (e.g., one, two, ten, one hundred, all) of the devices. In another example, the search may be based on a predetermined number of devices to be searched in combination with a predetermined number of search results to be obtained. In another example, the searching structures may be based on one or more specific games. In another example, the searching structure may be based on a player's preferences, past transactional history, player input, a particular hybrid arcade/wager-based game or game type, a particular EGD, a particular casino, a particular location within a casino, game outcomes over a time period, payout over a time period, and/or any other criteria. Searching algorithms may be dynamic searching programs, which may be modified based on one or more past results, as described previously. In another example, the search algorithm may generate a search priority based on the probability of success various events and/or conditions. In some embodiments, the search algorithm may utilize any dynamic feedback procedure to enhance current and/or future searching results.

Account module 432 may include data relating to an account balance, a wager limit, a number of wagers placed, credit limits, any other player information, and/or any other account information. Data from account module 432 may be utilized to determine whether a wager may be accepted. For example, when a search has determined a triggering event, the device and/or system may determine whether to allow this wager based on one or more of a wager amount, a number of wagers, a wager limit, an account balance, and/or any other criteria.

In at least one embodiment, at least a portion of the modules discussed in block diagram 400 may reside locally in gaming terminal 400. However, in at least some embodiments, at least part of the functions performed by these modules may be implemented in one or more remote servers. For instance, modules 406-420 and 424 may each be on a remote server, communicating with gaming terminal 400 via a network interface such as Ethernet in a local area network (LAN) or a wide area network (WAN) topology. In some implementations, these servers may be physical servers in a data center. In some other implementations, these servers may be virtualized. In yet some other implementations, the functions performed by these modules may be implemented as web services. For example, the predetermined game options module 408 may be implemented in software as a web service provider. Gaming terminal 400 would make service requests over the web for the available predetermined wager options to be displayed. Regardless of how the modules and their respective functions are implemented, the interoperability with the gaming terminal 400 is seamless. In one implementation, reporting module 418 may reside on a central server and may be configured to aggregate and generate real time statistics on betting activities at one or more hybrid arcade/wager-based games at one or more participating casinos. The aggregate betting statistics may include trends (e.g., aggregate daily wager volume and wager amount by game types, by casinos, and the like), top games with the most payouts, top EGDs with the most payouts, top search structures used by players, most popular hybrid arcade/wager-based game(s) by wager volume, most searched for game(s), EGDs with least payouts, weekly trends, monthly trends, and other statistics related to game plays, wagers, people, location, and searches.

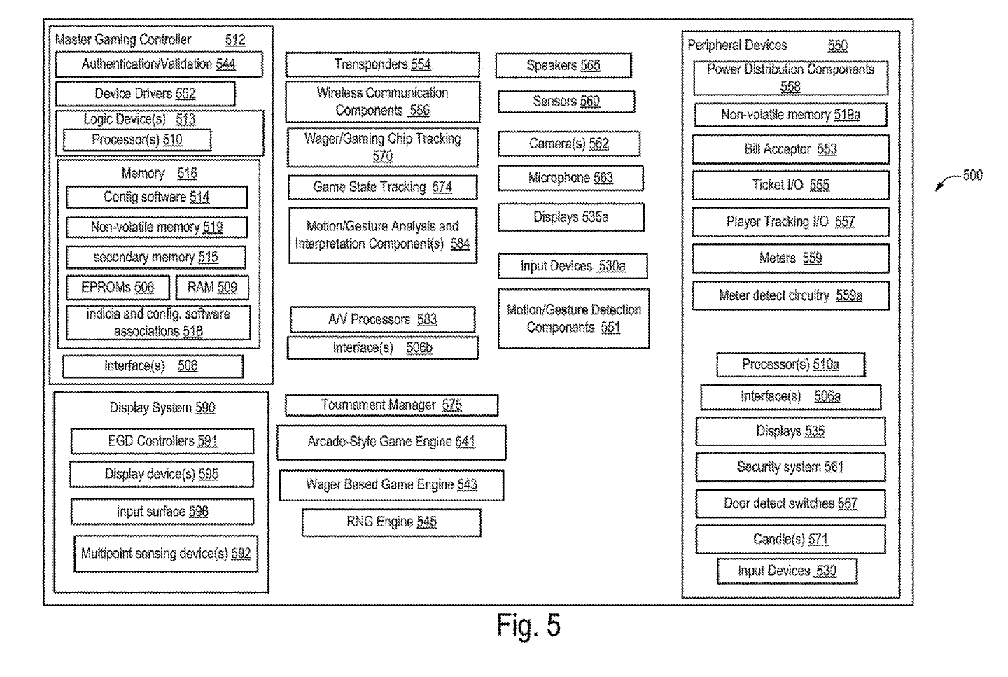

FIG. 5 is a block diagram of an exemplary intelligent multi-player electronic gaming system 500 according to one embodiment. Gaming system 500 may be implemented as a gaming server or as an electronic gaming machine (e.g., EGM) or electronic gaming device (e.g., EGD).

As shown, gaming system 500 may include at least one processor 510, at least one interface 506, and memory 516. Additionally, gaming system 500 may include at least one master gaming controller 512, a multi-touch sensor and display system 590, a plurality of peripheral device components 550, and various other components, devices, systems such as, for example, arcade-style game engine(s) 541; wager-based game engine(s) 543; RNG engine(s) 545; transponders 554; wireless communication components 556; gaming chip/wager token tracking components 570; games state tracking components 574; motion/gesture analysis and interpretation components 584, and audio/video processors 583 which, for example, may include functionality for detecting, analyzing and/or managing various types of audio and/or video information relating to various activities at the gaming system. Various interfaces 506b may be provided for communicating with other devices, components and systems, as may be tournament manager 575; sensors 560; one or more cameras 562; one or more microphones 563; secondary display(s) 535a; input devices 530a; motion/gesture detection components 551; and peripheral devices 550.

The arcade-style game engine(s) 541 may be configured to manage the arcade-style game play portion (or entertainment portion) of the hybrid arcade/wager-based game. Conversely, the wager-based game engine(s) 543 may be configured to manage the wager-based game event portion(s) of the hybrid arcade/wager-based game. RNG engine(s) 545 may include software and/or hardware algorithm and/or processes used to generate random outcomes, and may be used by the wager-based game engine to generate wager-based game event outcomes. Monetary payout manager 522 may be configured or designed to include functionality for determining the appropriate monetary payout(s) (if any) to be distributed to player(s) based on the outcomes of the wager-based game events which are initiated during play of one or more hybrid arcade/wager-based games. The non-monetary payout manager 524 may be configured to include functionality for determining the appropriate non-monetary payout(s) (if any) to be awarded or distributed to player(s) based on the outcomes of the wager-based game events which are initiated during play of one or more hybrid arcade/wager-based games.

One or more cameras (e.g., 562) may be used to monitor, stream and/or record image content and/or video content relating to persons or objects within each camera's view. For example, in at least one embodiment where the gaming system is implemented as an EGD, camera 562 may be used to generate a live, real-time video feed of a player (e.g., or other person) who is currently interacting with the EGD. In some embodiments, camera 562 may be used to verify a user's identity (e.g., by authenticating detected facial features), and/or may be used to monitor or tract facial expressions and/or eye movements of a user or player who is interacting with the gaming system.

In at least one embodiment, display system 590 may include EGD controllers 591; multipoint sensing device(s) 592 (e.g., multi-touch surface sensors/components); display device(s) 595; and Input/touch surface 596. According to embodiments, display surface(s) 595 may include one or more display screens. Master gaming controller 512 may include authentication/validation components 544; device drivers 552; logic devices 513, which may include one or more processors 510; memory 516, which may include configuration software 514, non-volatile memory 519, EPROMS 508, RAM 509, associations 518 between indicia and configuration software, and interfaces 506.

In at least one embodiment, the peripheral devices 550 may include power distribution components 558; non-volatile memory 519a (e.g., and/or other types of memory); bill acceptor 553; ticket I/O 555; player tracking I/O 557; meters 559 (e.g., hard and/or soft meters); meter detect circuitry 559a; processor(s) 510a; interface(s) 506a; display(s) 535; independent security system 561; door detect switches 567; candles, etc. 571; input devices 530, for example.

In one implementation, processor 510 and master gaming controller 512 may be included in a logic device 513 enclosed in a logic device housing. The processor 510 may include any conventional processor or logic device configured to execute software (i.e., sequences of computer-readable instructions to be executed) allowing various tasks such as communicating with a remote source via communication interface 506, such as a server that stores authentication information or games; converting signals read by an interface to a format corresponding to that used by software or memory in the gaming system; accessing memory to configure or reconfigure game parameters in the memory according to indicia read from the device; communicating with interfaces, various peripheral devices and/or I/O devices; operating peripheral devices such as, for example, card readers, paper ticket readers, etc.; operating various I/O devices such as, for example, displays 535 and input devices 530. For instance, the processor 510 may send messages including game play information to the displays 535 to inform players of game play/event information, wagering information, and/or other desired information.

In at least one implementation, the gaming system may include card readers such as used with credit cards, or other identification code reading devices to allow or require player identification in connection with play of the card game and associated recording of game action. Such a player identification interface can be implemented in the form of a variety of magnetic and/or chip-card card readers commercially available for reading a player-specific identification information. The player-specific information can be provided on specially constructed magnetic cards issued by a casino, or magnetically coded credit cards or debit cards frequently used with national credit organizations such as Visa, MasterCard, American Express, or banks and other institutions.

The gaming system may include other types of participant identification mechanisms which may use a fingerprint image, eye blood vessel image reader, or other suitable biometric information to confirm identity of the player. Such personalized identification information could also be used to confirm credit use of a smart card, transponder, and/or player's personal player input device (e.g., UID).

The gaming system 500 also includes memory 516 which may include, for example, volatile memory (e.g., RAM 509), non-volatile memory 519 (e.g., disk memory, FLASH memory, EPROMs, etc.), unalterable memory (e.g., EPROMs 508), etc. The memory may be configured or designed to store, for example: 1) configuration software 514 such as all the parameters and settings for a game playable on the gaming system; 2) associations 518 between configuration indicia read from a device with one or more parameters and settings; 3) communication protocols allowing the processor 510 to communicate with peripheral devices and I/O devices 4) a secondary memory storage device 515 such as a non-volatile memory device, configured to store gaming software related information (e.g., the gaming software related information and memory may be used to store various audio files and games not currently being used and invoked in a configuration or reconfiguration); 5) communication transport protocols (e.g., such as, for example, TCP/IP, USB, Firewire, IEEE1394, Bluetooth, IEEE 802.11x (e.g., IEEE 802.11 standards), hiperlan/2, HomeRF, etc.) for allowing the gaming system to communicate with local and non-local devices using such protocols; etc. In one implementation, the master gaming controller 512 communicates using a serial communication protocol. A few examples of serial communication protocols that may be used to communicate with the master gaming controller include but are not limited to USB, RS-232 and Netplex (e.g., a proprietary protocol developed by IGT, Reno, Nev.).

A plurality of device drivers 552 may be stored in memory 516. Example of different types of device drivers may include device drivers for gaming system components, device drivers for gaming system components, etc. The device drivers 552 may utilize a communication protocol of some type that enables communication with a particular physical device. The device driver abstracts the hardware implementation of a device. For example, a device driver may be written for each type of card reader that may be potentially connected to the gaming system. Examples of communication protocols used to implement the device drivers include Netplex, USB, Serial, Ethernet, Firewire, I/O debouncer, direct memory map, serial, PCI, parallel, RF, Bluetooth™, near-field communications (e.g., using near-field magnetics), 802.11 (e.g., Wi-Fi), etc. When one type of a particular device is exchanged for another type of the particular device, a new device driver may be loaded from the memory 516 by the processor 510 to allow communication with the device. For instance, one type of card reader in gaming system 500 may be replaced with a second type of card reader where device drivers for both card readers are stored in the memory 516.

The software units stored in the memory 516 may be upgraded as needed. For instance, when the memory 516 is a hard drive, new games, game options, various new parameters, new settings for existing parameters, new settings for new parameters, device drivers, and new communication protocols may be uploaded to the memory from the master gaming controller 512 or from some other external device. As another example, when the memory 516 includes a CD/DVD drive including a CD/DVD designed or configured to store game options, parameters, and settings, the software stored in the memory may be upgraded by replacing a second CD/DVD with a second CD/DVD. In yet another example, when the memory 516 uses one or more flash memory 519 or EPROM 508 units designed or configured to store games, game options, parameters, settings, the software stored in the flash and/or EPROM memory units may be upgraded by replacing one or more memory units with new memory units which include the upgraded software. One or more of the memory devices, such as the hard-drive, may be employed in a game software download process from a remote software server.

The gaming system 500 may also include various authentication and/or validation components 544 which may be used for authenticating/validating specified gaming system components such as, for example, hardware components, software components, firmware components, information stored in the gaming system memory 516, etc.

Sensors 560 may include, for example, optical sensors, pressure sensors, RF sensors, Infrared sensors, motion sensors, audio sensors, image sensors, thermal sensors, biometric sensors, etc. As mentioned previously, such sensors may be used for a variety of functions such as, for example: detecting the presence and/or monetary amount of gaming chips which have been placed within a player's wagering zone and/or detecting (e.g., in real time) the presence and/or monetary amount of gaming chips which are within the player's personal space, for example. In one implementation, at least a portion of the sensors 560 and/or input devices 530 may be implemented in the form of touch keys selected from a wide variety of commercially available touch keys used to provide electrical control signals. Alternatively, some of the touch keys may be implemented by a touchscreen display. For example, in at least one implementation, the gaming system player may include input functionality for enabling players to provide their game play decisions/instructions (e.g., and/or other input) to the EGD using the touch keys and/or other player control sensors/buttons. Additionally, such input functionality may also be used for allowing players to provide input to other devices in the casino gaming network (e.g., such as, for example, player tracking systems, side wagering systems, etc.)

Wireless communication components 556 may include one or more communication interfaces having different architectures and utilizing a variety of protocols such as, for example, 802.11 (e.g., Wi-Fi), 802.15 (e.g., including Bluetooth™), 802.16 (e.g., WiMAX), 802.22, Cellular standards such as CDMA, CDMA2000, WCDMA, Radio Frequency (e.g., RFID), Infrared, Near Field Magnetic communication protocols, etc. The communication links may transmit electrical, electromagnetic or optical signals which carry digital data streams or analog signals representing various types of information. An example of a near-field communication protocol is the ECMA-340 “Near Field Communication--Interface and Protocol (e.g., NFCIP-1)”, published by ECMA International (e.g., www.ecma-international.org), herein incorporated by reference in its entirety for all purposes. It will be appreciated that other types of Near Field Communication protocols may be used including, for example, near field magnetic communication protocols, near field RF communication protocols, and/or other wireless protocols which provide the ability to control with relative precision (e.g., on the order of centimeters, inches, feet, meters, etc.) the allowable radius of communication between at least 5 devices using such wireless communication protocols.

Power distribution components 558 may include, for example, components or devices which are operable for providing wireless power to other devices. For example, in one implementation, the power distribution components 558 may include a magnetic induction system which is adapted to provide wireless power to one or more portable UIDs at the gaming system. In one implementation, a UID docking region may include a power distribution component which is able to recharge a UID placed within the UID docking region without requiring metal-to-metal contact.

A motion/gesture detection component(s) 551 may be configured or designed to detect player movements and/or gestures and/or other input data from the player. In some implementations, each gaming system may have its own respective motion/gesture detection component(s). In other embodiments, motion/gesture detection component(s) 551 may be implemented as a separate sub-system of the gaming system which is not associated with any one specific gaming system or device.

FIG. 6 is a block diagram of an exemplary mobile gaming device 600 in accordance with a specific embodiment. In at least one embodiment, one or more players may participate in a game session using mobile gaming devices. In at least some embodiments, the mobile gaming device may be configured or designed to include or provide functionality which is similar to that of an electronic gaming device (e.g., EGD) such as that described, for example, in FIG. 4.

As shown in FIG. 6, mobile gaming device 600 may include mobile device application components (e.g., 660), which, for example, may include UI components 662; database components 664; processing components 666 and/or other components 668 which, for example, may include components for facilitating and/or enabling the mobile gaming device to carry out the functionality described herein.

The mobile gaming device 600 may include mobile device app component(s) that have been configured or designed to provide functionality for enabling or implementing at least a portion of the functionality of the hybrid arcade/wager-based game techniques at the mobile gaming device.

According to embodiments, various aspects, features, and/or functionalities of the mobile gaming device may be performed, implemented and/or initiated by processor(s) 610; device drivers 642; memory 616; interface(s) 606; power source(s)/distribution 643; geolocation module 646; display(s) 635; I/O devices 630; audio/video devices(s) 639; peripheral devices 631; motion detection module 640; user identification/authentication module 647; client app component(s) 660; other component(s) 668; UI Component(s) 662; database component(s) 664; processing component(s) 666; software/hardware authentication/validation 644; wireless communication module(s) 645; information filtering module(s) 649; operating mode selection component 648; speech processing module 654; scanner/camera 652 and/or OCR processing engine 656, for example.

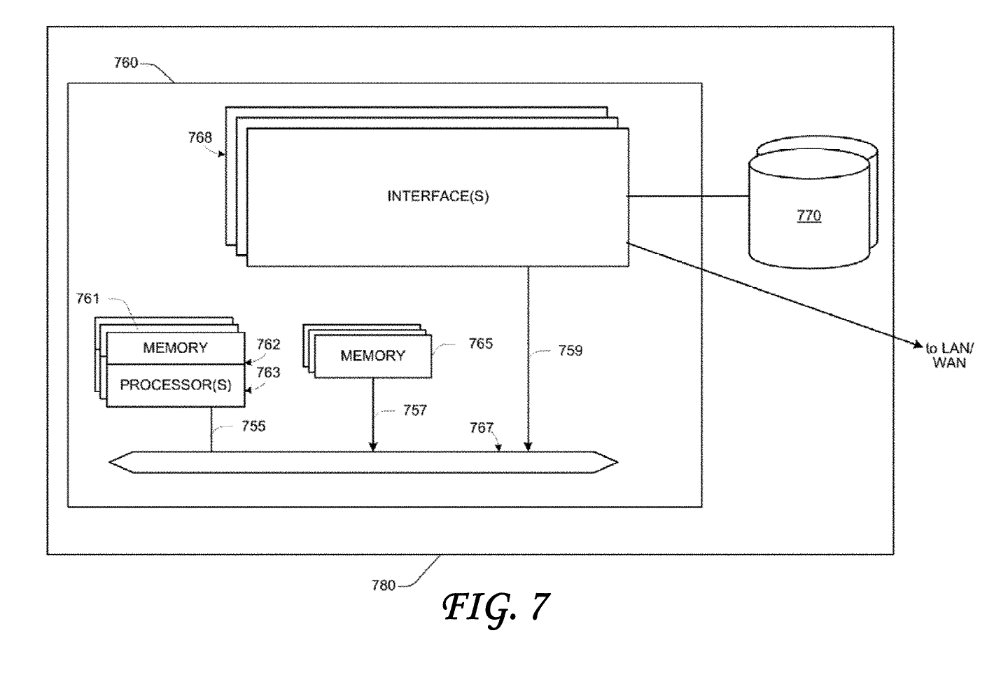

FIG. 7 shows a system server 780 that may be configured according to embodiments. The system server 780 may include at least one network device 760, and at least one storage device 770 (e.g., such as, for example, a direct attached storage device). In one embodiment, system server 780 may be configured to implement at least some of the hybrid arcade/wager-based game techniques described herein. Network device 760 may include a master central processing unit (e.g., CPU) 762, interfaces 768, and a bus 767 (e.g., a PCI bus). When acting under the control of appropriate software or firmware, the CPU 762 may be responsible for implementing specific functions associated with the functions of a desired network device. For example, when configured as a server, the CPU 762 may be responsible for analyzing packets; encapsulating packets; forwarding packets to appropriate network devices; instantiating various types of virtual machines, virtual interfaces, virtual storage volumes, virtual appliances; etc. The CPU 762 preferably accomplishes at least a portion of these functions under the control of software including an operating system (e.g., Linux), and any appropriate system software (e.g., such as, for example, AppLogic (e.g., TM) software).

CPU 762 may include one or more processors 763 such as, for example, one or more processors from the AMD, Motorola, Intel and/or MIPS families of microprocessors. In an alternative embodiment, processor 763 may be specially designed hardware for controlling the operations of system server 780. In a specific embodiment, a memory 761 (e.g., such as non-volatile RAM and/or ROM) also forms part of CPU 762. However, there are different ways in which memory could be coupled to the system. Memory block 761 may be used for a variety of purposes such as, for example, caching and/or storing data, programming instructions, etc.

Interfaces 768 may be typically provided as interface cards. Alternatively, one or more of the interfaces 768 may be provided as on-board interface controllers built into the system motherboard. Generally, they control the sending and receiving of data packets over the network and sometimes support other peripherals used with the system server 780. Among the interfaces that may be provided may be FC interfaces, Ethernet interfaces, frame relay interfaces, cable interfaces, DSL interfaces, token ring interfaces, InfiniBand interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (e.g., Wi-Fi) interfaces, 802.15 interfaces (e.g., including Bluetooth™) 802.16 (e.g., WiMAX) interfaces, 802.22 interfaces, Cellular standards such as CDMA interfaces, CDMA2000 interfaces, WCDMA interfaces, TDMA interfaces, Cellular 3G interfaces, and the like.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 762 to efficiently perform routing computations, network diagnostics or security functions.

In at least one embodiment, some interfaces may be configured or designed to allow the system server 780 to communicate with other network devices associated with various local area network (e.g., LANs) and/or wide area networks (e.g., WANs). Other interfaces may be configured or designed to allow network device 760 to communicate with one or more direct attached storage device(s) 770.

Regardless of network device's configuration, it may employ one or more memories or memory modules (e.g., such as, for example, memory block 765, which, for example, may include random access memory (e.g., RAM)) configured to store data, program instructions, logic and processes for the general-purpose network operations and/or other information relating to the functionality of the embodiments described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (e.g., ROM) and random-access memory (e.g., RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

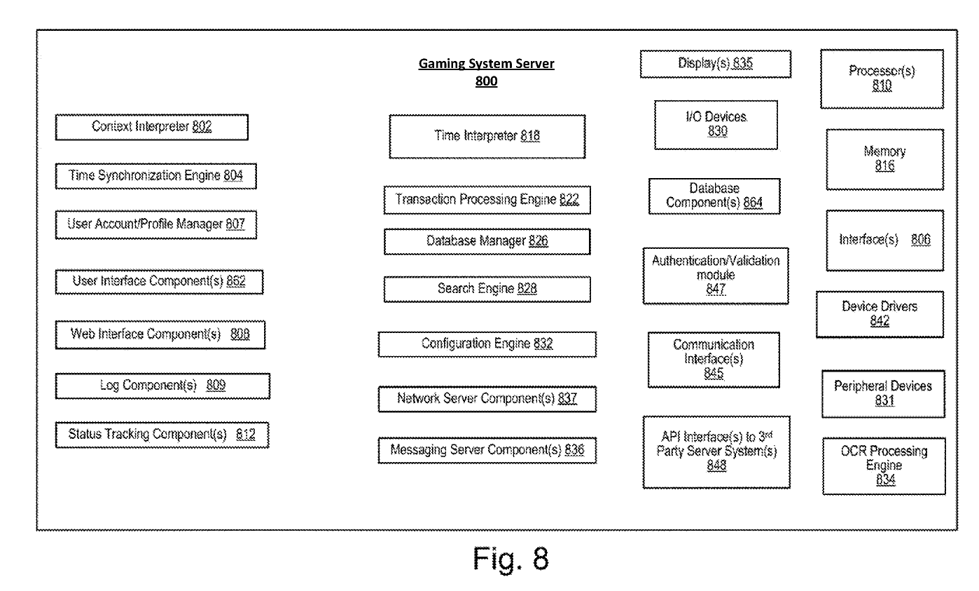

FIG. 8 illustrates an example of a functional block diagram of a gaming system server in accordance with a specific embodiment. As shown, the gaming system server 800 may a context interpreter 802 which, for example, may be operable to automatically and/or dynamically analyze contextual criteria relating to a detected set of event(s) and/or condition(s), and automatically determine or identify one or more contextually appropriate response(s) based on the contextual interpretation of the detected event(s)/condition(s). Examples of contextual criteria which may be analyzed may include, but are not limited to, for example, location-based criteria (e.g., geolocation of mobile gaming device, geolocation of EGD, time-based criteria, identity of user(s), user profile information, transaction history information and recent user activities, for example. Time synchronization engine 804 may be operable to manage universal time synchronization (e.g., via NTP and/or GPS). The search engine 828 may be operable to search for transactions, logs, game history information, player information, hybrid arcade/wager-based game information, etc., which may be accessed from one or more local and/or remote databases. The gaming system server 800 may also include a configuration engine 832 that may be configured to determine and handle configuration of various customized configuration parameters for one or more devices, component(s), system(s), and process(es). Time interpreter 818 may be operable to automatically and/or dynamically modify or change identifier activation and expiration time(s) based on various criteria such as, for example, time, location, transaction status, etc. Authentication/validation component(s) 847 (e.g., password, software/hardware info, SSL certificates) may be operable to perform various types of authentication/validation tasks. The transaction processing engine 822 may be operable to handle various types of transaction processing tasks such as, described and/or referenced herein. An OCR processing engine 834 may be operable to perform image processing and optical character recognition of images such as those captured by a gaming device camera, for example. The database manager 826 may be configured to handle various types of tasks relating to database updates, management and access. In at least one embodiment, the database manager may be operable to manage game history databases, player tracking databases and/or other historical record keeping. Log component(s) 809 may be operable to generate and manage transactions history logs, system errors, connections from APIs. Status tracking component(s) 812 may be provided and configured to automatically and/or dynamically determine, assign, and/or report updated transaction status information based, for example, on a state of the transaction. Gateway component(s) may be operable to facilitate and manage communications and transactions with external payment gateways. Web interface component(s) 808 may be operable to facilitate and manage communications and transactions with virtual live electronic gaming device web portal(s). API interface(s) to gaming system server(s) may be operable to facilitate and manage communications and transactions with API Interface(s) to the gaming system server(s). API Interface(s) to 3rd party system server(s) may be provided, which may be operable to facilitate and manage communications and transactions with API interface(s) to 3rd party system server(s).

One or more general-purpose processors 810 may be provided. In an alternative embodiment, at least one processor may be specially designed hardware for controlling the operations of a gaming system. In a specific embodiment, a memory (e.g., such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software. Memory 816 may be provided. The memory 816 may include volatile memory (e.g., RAM), non-volatile memory (e.g., disk memory, FLASH memory, EPROMs, etc.), unalterable memory, and/or other types of memory. According to different embodiments, one or more memories or memory modules (e.g., memory blocks) may be configured or designed to store data, program instructions for the functional operations of the mobile gaming system and/or other information. The program instructions may control the operation of an operating system and/or one or more applications, for example. The memory or memories may also be configured to store data structures, metadata, identifier information/images, and/or information/data relating to other features/functions described herein. Interface(s) 806 may be provided such as, for example, wired interfaces and/or wireless interfaces. Suitable device driver(s) 842 may also be provided, as may be one or more display(s) 835. Messaging server component(s) 836, may provide various functions and operations relating to messaging activities and communications. Similarly, network server component(s) 837may be configured to provide various functions and operations relating to network server activities and communications. User account/profile manager component(s) 807 may be provided to manage various aspects of user accounts and/or profiles.

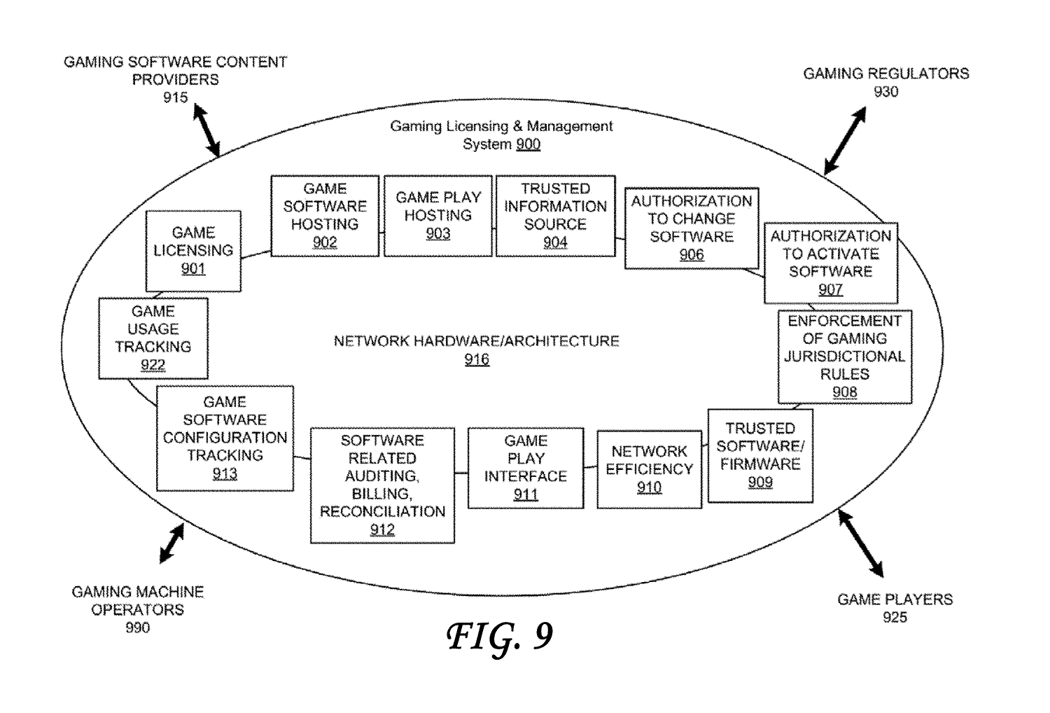

FIG. 9 shows a block diagram illustrating components of a gaming system 900 suitable for implementing various aspects of the embodiments shown and described herein. In FIG. 9, the components of a gaming system 900 for providing game software licensing and downloads are described functionally. The described functions may be instantiated in hardware, firmware and/or software and executed on a suitable device. In the system 900, there may be many instances of the same function, such as multiple game play interfaces 911. Nevertheless, in FIG. 9, only one instance of each function is shown. The functions of the components may be combined. For example, a single device may comprise the game play interface 911 and include trusted memory devices or sources 909.

The gaming system 900 may receive inputs from different groups/entities and output various services and or information to these groups/entities. For example, game players 925 primarily input cash or indicia of credit into the system, make game selections that trigger software downloads, and receive entertainment in exchange for their inputs. Game software content providers provide game software for the system and may receive compensation for the content they provide based on licensing agreements with the gaming machine operators. Gaming machine operators select game software for distribution, distribute the game software on the gaming devices in the system 900, receive revenue for the use of their software and compensate the gaming machine operators. The gaming regulators 930 provide rules and regulations that are applicable to the gaming system and receive reports and other information confirming adherence to these rules.

The game software license host 901 may be a server connected to a number of remote gaming devices that provides licensing services to the remote gaming devices. For example, the license host 901 may 1) receive token requests for tokens used to activate software executed on the remote gaming devices, 2) send tokens to the remote gaming devices, 3) track token usage and 4) grant and/or renew software licenses for software executed on the remote gaming devices. The token usage may be used in use-based licensing schemes, such as a pay-per-use scheme.

In another embodiment, a game usage-tracking host 922 may track the usage of game software on a plurality of devices in communication with the host. The game usage-tracking host 922 may be in communication with a plurality of game play hosts and gaming machines. From the game play hosts and gaming machines, the game usage tracking host 922 may receive updates of an amount that each game available for play on the devices may be played and on amount that may be wagered per game. This information may be stored in a database and used for billing according to methods described in a utility based licensing agreement.

The game software host 902 may provide game software downloads, such as downloads of game software or game firmware, to various devices in the game system 900. For example, when the software to generate the game is not available on the game play interface 911, the game software host 902 may download software to generate a selected game of chance played on the game play interface. Further, the game software host 902 may download new game content to a plurality of gaming machines responsive to a request from a gaming machine operator.

The game software host 902 may also include a game software configuration-tracking host 913. The function of the game software configuration-tracking host is to keep records of software configurations and/or hardware configurations for a plurality of devices in communication with the host (e.g., denominations, number of paylines, paytables, max/min wagers).

A game play host device 903 may include a host server connected to a plurality of remote clients that generates games of chance that are displayed on a plurality of remote game play interfaces 911. For example, the game play host device 903 may include a server that provides central determination of wager outcomes on a plurality of connected game play interfaces 911. As another example, the game play host device 903 may generate games of chance, such as slot games or wager-based video games, for display on a remote client. A game player using the remote client may be able to select from a number of games that are provided on the client by the host device 903. The game play host device 903 may receive game software management services, such as receiving downloads of new game software, from the game software host 902 and may receive game software licensing services, such as the granting or renewing of software licenses for software executed on the device 903, from the game license host 901.

The game play interfaces or other gaming devices in the gaming system 900 may be portable devices, such as electronic tokens, cell phones, smart cards, tablet PCs and PDAs. The portable devices may support wireless communications. The network hardware architecture 916 may be enabled to support communications between wireless mobile devices and other gaming devices in gaming system. The wireless mobile devices may be used to play games of chance, such as described herein.

The gaming system 900 may use a number of trusted information sources. Trusted information sources 904 may include devices, such as servers, that provide information used to authenticate/activate other pieces of information. Cyclic Redundancy Check (CRC) values used to authenticate software, license tokens used to allow the use of software or product activation codes used to activate software are examples of trusted information that might be provided from a trusted information source 904. Trusted information sources may include a memory device, such as an EPROM, that includes trusted information used to authenticate other information. For example, a game play interface 911 may store a private encryption key in a trusted memory device that is used in a private key-public key encryption scheme to authenticate information from another gaming device.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering may be detected.

The gaming system 900 of example embodiments may include devices 906 that provide authorization to download software from a second device to a second device and devices 907 that provide activation codes or information that allow downloaded software to be activated. The devices, 906 and 907, may be remote servers and may also be trusted information sources.

A device 906 that monitors a plurality of gaming devices to determine adherence of the devices to gaming jurisdictional rules 908 may be included in the system 900. A gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRCs, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum wager limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. When a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system 900 may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, e.g., game software approved for use on gaming devices by a local gaming jurisdiction may be required on gaming devices on the gaming machine.

The devices may be connected by a network 916 with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to viable. Thus, network efficient devices 910 may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices may provide game software and game licensing related auditing, billing and reconciliation reports to server 912. For example, a software licensing billing server may generate a bill for a gaming device operator based upon a usage of games over a time period on the gaming devices owned by the operator. In another example, a software auditing server may provide reports on game software downloads to various gaming devices in the gaming system 900 and current configurations of the game software on these gaming devices.

At particular time intervals, the software auditing server 912 may also request software configurations from a number of gaming devices in the gaming system. The server may then reconcile the software configuration on each gaming device. The software auditing server 912 may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

The term “roguelike” refers to a subgenre of role-playing video games, often characterized by a crawl through procedurally-generated game levels, turn-based gameplay, tile-based graphics, and permanent death of the player-character. Most roguelikes are based on a high fantasy narrative, reflecting their influence from tabletop role playing games such as Dungeons & Dragons. Deriving from the concepts of such tabletop role-playing games, nearly all roguelikes give the player control of a character, with adjustable attributes points and skills. At the start of the game, the character may be placed at the top-most level of a dungeon or other locale, with basic equipment such as a simple weapon, armor, torches, and food. Following along the role-playing concept, the player moves the character through the dungeon, collecting treasure that can include new weapons, armors, magical devices, potions, scrolls, food, and in-game money, while having to fight monsters that roam the dungeon. Most combat is performed simply by attempting to move the character into the same space as the monster, which the game then calculates the damage that the character and monster deal. Other types of attacks, such as firing an arrow or performing an offensive magic spell, can often be performed as well.

Defeating monsters in roguelike games can earn the character experience points, and after earning enough points, the character may gain an experience level, improving their hit points, magic capability, and other attributes.

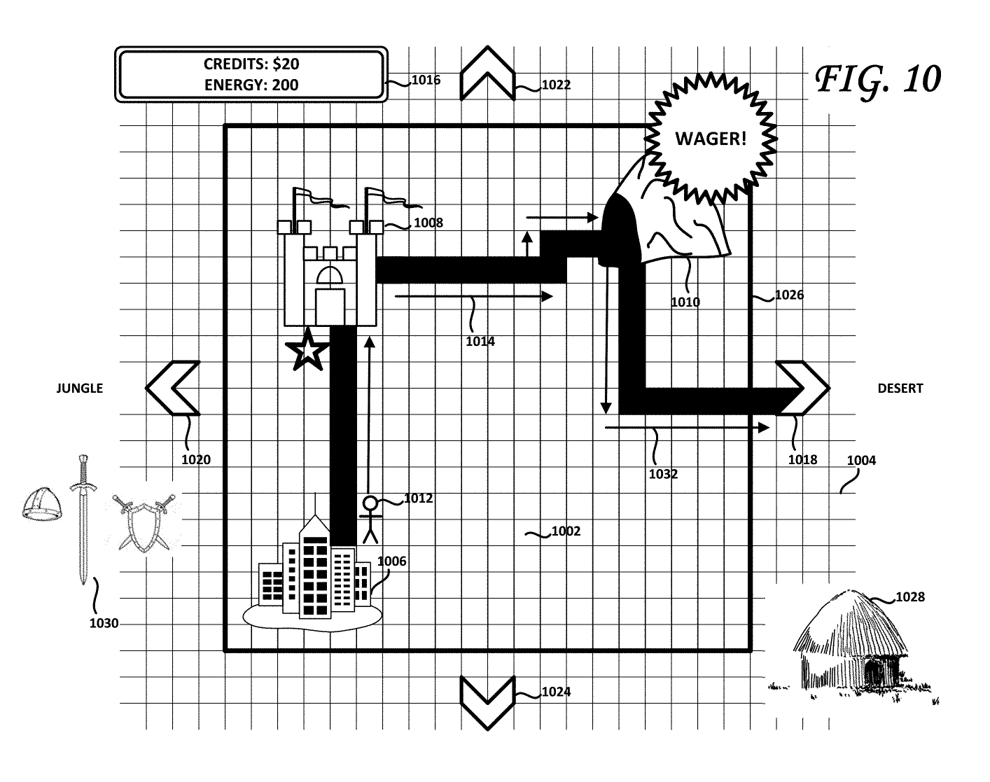

FIG. 10 is a representation of a wagering game according to one embodiment, suitable for a regulated gaming machine, such as the EGMs or EGDs described above. According to one embodiment, after accepting money (cash or any form of electronic money or credit) from the player to begin the game, a computer-generated landscape 1002 may be rendered on a display of the regulated gaming machine. In one embodiment, the landscape 1002 may be super-imposed on a grid 1004. A plurality of landmarks may be generated, rendered and disposed at respectively different locations within the computer-generated landscape 1002. For example, such landmarks may include a city or a village 1006, a castle 1008 and a cave 1010. According to one embodiment, the landmarks 1006, 1008 and 1010 may be disposed at random or predetermined locations within the computer-generated landscape 102. For example, a plurality of random numbers may be generated and a corresponding plurality of landmarks 1006, 1008 and 1010 may be disposed at respective locations, within the computer-generated landscape 1002, that are determined by the generated random numbers. Other methods of disposing the landmarks within the landscape may be devised and implemented. For example, a table of locations may be randomly indexed and used to determine the location of the landmarks within the landscape 1002. In one implementation, rules may be devised to prevent the aggregation of several landmarks within a small area within the computer-generated landscape 1002. According to one embodiment, the landscape and constituent landmarks may be procedurally generated, such that different landscapes and landmark emplacements are generated each time the game is played. Other alternatives will occur to those of skill in this art.

In one embodiment, one of more of these landmarks 1002 may be a wager-enabled landmark that is configured to initiate a wager. To interact with the landmarks, the regulated gaming machine may also generate a virtual avatar 1012 for the player and may place the virtual avatar 1012 somewhere within the computer-generated landscape 1004. The virtual avatar 1012 shown in FIG. 10 is a stick figure, although other shapes may be used, as may be greater degrees of realism or detail, depending upon the game designer's vision for the game. For example, the virtual avatar could be a spaceship, a submarine or a squirrel.

During game play, the regulated gaming machine may accept user input, via a suitable user interface, such as touch-based, buttons, joystick, steering wheel, track wheels and pads and the like. At least some of the accepted user inputs may be used by the regulated gaming machine to move the generated virtual avatar 1012 within the computer-generated landscape 1002. Any movement of the virtual avatar 1012 may be divided into one or more irreducible quantum of movement such as, in FIG. 10, one grid square of the grid 1004. The movement may be staccato, a step-wise movement one grid square at a time, or may appear to be more fluid in nature. For a more retro-themed game, the virtual avatar 1012 may be programmed to move grid square by grid square emulating, for example, old-school 8-bit graphics. For a more contemporary feel, the grid 1004 may be missing or at least invisible to the player and the avatar 1012 may be able to move in any direction in a fluid-like manner, as opposed to being limited to the four cardinal directions, as suggested in FIG. 10.

However the landscape 1002, the landmarks 1006, 1008 and 1010 and the virtual avatar 1012 are configured, movement of the player's virtual avatar 102 within the computer-generated landscape 1002 costs (i.e., results in the expenditure of) money and/or something of value. In one embodiment, the act of moving within the landscape 1002 debits some of the money accepted from the player for each unit of movement of the virtual avatar 1012 within the computer-generated landscape 1002. According to one embodiment, a “unit of movement” may correspond to the aforementioned irreducible quantum of movement, the shortest distance the avatar may be configured to travel. For example, between the city or village 1006 and the castle 1008, given the visible grid shown in FIG. 10, there are approximately seven units of movement, one unit of movement for each grid square. Therefore, should the player direct, through appropriate actions using the regulated gaming device's user interface, the virtual avatar 1012 to travel between the city or village 1006 and the castle 1008, the player's funds accepted by the regulated gaming machine may be debited by seven (in one embodiment, equal) amounts. In one embodiment, the landscape may include different elevations, which may make travel more difficult such as when moving uphill or easier, such as when moving downhill. In one embodiment, the relative ease of traveling over a given terrain may be reflected in the cost of moving. For example, moving uphill may cost the player 1.5 as much as when the player's virtual avatar moves upon level ground and moving downhill may cost the player only 0.5 times as much as when the player's virtual avatar moves upon level ground. Other features may be provided within the landscape to make movement easier (less costly to the player) and harder (more costly to the player).

Returning to FIG. 10, suppose that the player had inputted and the gaming machine received, $10. Suppose further that each unit of movement caused the player's funds to be debited by one cent. Therefore, it would cost the player seven cents ($0.07) for his or her virtual avatar 1012 to move from the city or village 1006 and the castle 1008. Therefore, the very act of moving within the landscape 1002 cost the player money, with longer distances costing more than comparatively shorter distances, according to one embodiment. Indeed, according to one embodiment, it is the act of moving within the landscape 1002 that cost the player money (or other value), with many or all other in-game activities (including being a randomly-determined amount of money or other value) being effectively free for the player, save for the cost incurred for the player's virtual avatar 1012 to reach that in-game activity.

As shown in FIG. 10, the virtual avatar 1012 may be moved, by the player of the regulated gaming machine, from the city or village 1012 to the castle 1008. In so doing, the player's funds may be debited an amount that is related to the distance between the two landmarks 1006, 1008. Upon arrival at the castle 1008, the player's virtual avatar 1012 may be given some in-game accessory or advantage, such as armor. Note that, according to one embodiment, the player does not spend money to “buy” the armor, as moving to the castle 1008 has already cost the player an amount corresponding to the number of movement units from the city or village 1006 to the castle 1008. In one embodiment, it is sufficient, to be given the armor, for the avatar to move towards and arrive at the castle 1008. In another embodiment, the player may be given the option of spending more of his or her funds on an upgraded armor or some other upgraded enhancement. In another embodiment, the player may attempt to perform some task to obtain the armor or other enhancement.

As suggested at 1014, the player may then decide to cause his or her virtual avatar 1012, now equipped with armor in the example being developed herein, to move from the castle 1008 to the cave 1010. Such a movement, according to one embodiment, may cost the player about 10 movement units or an amount that is proportional to the distance between the two landmarks.

Recall that one of more of the landmarks 1006, 1008, 1010 may be a wager-enabled landmark that is configured to initiate a wager. In this example, the cave 1010 is one such wager-enabled landmark. For example, an in-game asset such as a dragon may have taken up residence in the cave 1010. Once the player's virtual avatar 1012 arrives at the wager-enabled landmark (in this case, the cave 1010), player inputs may be received by the regulated gaming machine that cause the virtual avatar 1012 to interact with an in-game asset located at the wager-enabled landmark. In another embodiment, simply moving the player's virtual avatar 1012 to the cave 1010 may initiate the wager or cause the determination of the player's reward. In any event, a wager may then be initiated and a reward due to the player may be randomly determined. For example, the virtual avatar 1012 may arrive at the cave 1010, may interact with the dragon in-game asset hiding therein and cause a wager to be initiated. According to one embodiment, the interaction with the dragon in-game asset may simply be the act of the virtual avatar 1012 arriving at the cave 1010, thereby engaging in battle with the dragon without any further input from the player. In one embodiment, the initiation of the wager may comprise randomly determining an award due to the player by, for example, selecting and accessing the or a selected payout schedule of a plurality of payout schedules. A normalized or scaled random number may then be used as an index into the selected and accessed payout schedule and the amount (if any) due to the player may be determined.

Indeed, depending upon the outcome of the battle, the player may be awarded a randomly-determined amount such as an amount based upon, for example, the generation of a random number or upon a random indexing into a pre-generated table. For example, a random number may be drawn and normalized or scaled. This normalized or scaled random number may be applied to a selected payout schedule to determine the amount, if any, due to the player.

In an EGM or EGD, a payout schedule for a wager is a randomized monetary Return to a Player. Some alternative industry terms for a payout schedule may include paytable, payline, payback percentage or distribution. The phrase payout schedule is used and defined here to avoid ambiguity that may be inherent in these alternate terms.

In the simplest terms, a payout schedule can be described as a table of information. Each of the table's entries (rows) may include at least three elements (columns). One of the elements for an entry may include some identifying information for a wagering event or multiple wagering events. Another element of the Entry may include the probability (standard mathematical definition) of the event occurring. The other important element is the payback value for the wagering event, should the wagering event occur.

The overall Return to the Player (also known as RTP) along with the payback values in the table are generally expressed as either (a) a multiple of the wager or (b) a specific value, such as a dollar (or other currency) amount. All entries in a payout schedule should be expressed in the same terms, as mixing wager multiples and specific values will typically not yield useful information.

In other implementations of a payout schedule, these listed values may not be explicitly present in the table, but may instead be indirectly indicated. For instance, if two six-sided dice were used as a lookup into a payout schedule, the probability of a seven (7) being rolled is higher than any other number. If seven was indicated in the actual payout schedule, it would be indirectly related to the probability of the 7 being rolled (which is ⅙, or 0.1666666 . . . ) Those of skill in the art will recognize that there are many alternate methods of expressing a probability, as well as many alternate methods of specifying a payback value. For instance, rather than specifying the payback value in terms of dollars and cents, or as a multiple of a wager, it could be expressed instead as the value of a re-spawned virtual avatar or the value of a Progressive Prize. For clarity, this description will assume that probabilities are real numbers between 0 and 1 inclusive, while payback values will either be multiples of the wager (expressed as percentages) or constant values (such as one dollar ($1)).

Herein, the sum of all probabilities in a payout schedule will equal 1 in a complete payout schedule. It is acceptable to assume that a payout schedule has a missing entry if the sum of all probabilities is less than 1. This missing entry's probability is equal to one minus the sum of the existing probabilities. The payback value of the missing entry is zero. If the sum of the probabilities is greater than one, the payout schedule is invalid.

To use a payout schedule, a random value must be generated. This random value must be used such that each entry in the payout schedule can be identified using some transformation of the random value combined with some form of look-up into the payout schedule using the Probability of each entry. For example, consider the following payout schedule in Table 1:

TABLE 1

| Event | Probability | payback value |
|---|---|---|
| Die Roll = 1 or 2 or 3 | .5 | $0 |
| Die Roll = 4 | .166666 . . . | $1 |
| Die Roll = 5 | .166666 . . . | $2 |
| Die Roll = 6 | .166666 . . . | $3 |

The value of a payout schedule is a sum of products. Each entry in the payout schedule will have its own entry value. This entry value is simply the product of the probability and the payback value. The value of the payout schedule is the sum of all entry values in the payout schedule. Therefore, for the payout schedule of Table 1, its value is calculated as shown below:

(0.5*$0)+(0.166666*$1)+(0.166666*$2)+(0.166666*$3)=$1.0

In this case, if the wager was $1, and the expected value was $1, the casino (and the player) would expect to neither win nor lose money on this game over time.

Note that random values may have different distributions. Most typical gaming devices use a uniform distribution, as a single random number is used to determine some outcome, such as a reel stop position, a wheel position, the value of a playing card, etc. However, some games or gaming devices may be configured to use a non-uniformly distributed random outcome. One such non-uniform random distribution is the Gaussian distribution. A Gaussian distribution (also known as a Normal distribution) is obtained whenever the sum of multiple uniformly distributed random numbers is calculated. For example, if the sum of two 6-sided dice is used to determine how much to pay the player, the outcome of 7 is more common than any other outcome by virtue of the Gaussian distribution of the random result of summing two 6-sided dice. The outcome is still completely random—it's just not uniformly distributed between 2 and 12. The examples used in this description will assume the generation of random numbers that are uniformly distributed unless otherwise specified. Note, however, that this does not preclude the use of non-uniform distributions in alternate embodiments.

In compliance with virtually all US-based gaming regulations, the randomized return must not be based on any previous actions or outcomes. Therefore, a gaming device is not typically permitted to alter the outcome of a random number generator because the gaming device has paid more or less than some target percentage over time. Therefore, the description and embodiments herein will assume the same constraint.

There are a large number of gambling games that are legal to play in the United States that can be reduced to one or more payout schedules. For example, the simple game of Roulette uses a uniformly-distributed random value (the ball landing somewhere on the wheel) along with a set of rules that denote the payout for each of the various possible outcomes. The payout for “black” is usually one-for-one: If you wager $1 on “black”, and the ball lands on a “black” number, you will receive $1 for every $1 bet (aka 2 to 1 odds) For this wager, there are 18 black numbers, 18 red numbers, and (hypothetically) 2 green numbers (0 and 00). The frequency of getting black is 18/38, or roughly 47.4%, and has a value of 2. The frequency of getting “not-black” is roughly 52.6%, and has a value of 0. Therefore, the value to the player (the payout schedule value) for “black” wager on roulette is:

(2*47.4%)+(0*52.6%)=94.8%

In other words, the casino can expect to win (after many millions of wagers) 1−0.948=0.052, or 5.2 cents, for every dollar wagered on “black” in Roulette. Note: Because no units (currency) was set on the payback values, it can be assumed that they are unit-less and, therefore, suitable to be used as a Multiplier for the Wager.

A classic slot machine follows a similar schedule. Each possible combination of symbols on the screen (or on a payline) has a specific probability of occurring. That combination also has a payback value (return to player). This payback value may be zero, or it may be millions of dollars. Using the same basic formula that was used in the simple wager of “black” on Roulette, the overall payback percentage of a slot machine is determined by summing up the products of each symbol combination's probability of occurring and the payback value for that combination of symbols.

Over a sufficiently long period of time, the value of a payout schedule converges to a constant, designed value (94.8% in the previous Roulette example). For purposes of calculating the theoretical RTP of a game, regardless of the individual details comprising a payout schedule (Roulette vs. slot machine vs. other), if the values of two payout schedules (as calculated above) are the same, then the theoretical RTP for the wager will be the same. As such, the use of the term “value of the payout schedule” is inclusive of every possible way that a payout schedule can be constructed.

For instance, if an example stated: “Carrying out a predetermined action (e.g., reaching a castle, slaying a dragon, etc.) results in the evaluation of a payout schedule with a value of 91%”, no assumption should be made about how the payout schedule is constructed. In one embodiment, the rolling of a die may be used as the value of the payout schedule. In another embodiment, a slot machine outcome may be used to determine the value of the payout schedule. In yet another embodiment, the spinning of a virtual wheel may be used to determine the value of the payout schedule. For example, a randomized lookup into a lookup-table may be used to establish the value of the payout schedule.

Even if two payout schedules have the same value, the payout schedules may have very different volatilities. In the simplest terms, a payout schedule with a higher volatility will require more wagers to converge to some given confidence interval (standard statistical definition) around the payout schedule value than a payout schedule with a lower volatility. In many (if not most) gambling games, combining the theoretical payback value with the volatility is a significant part of the craftsmanship behind mathematical game design. Unless noted otherwise, the volatility of a payout schedule does not affect the use of the term payout schedule—two payout schedules with the same value may be considered equivalent in various alternate embodiments and examples described herein. Various terms such as counters, tokens, achievements, etc. will all be called counters in this description.

Regardless of how configured, the game must be considered “fair”. A primary tenet regarding fairness is that the rules of the game must be completely described to the player, such that the player may make an informed decision whether or not to play the game based on how the game is played. This rule applies to all known regulated gaming jurisdictions. The gaming embodiments shown and described herein are fair and it is assumed that the rules of the game are clearly described to the player.

Also, the game must never pay out so much money that the casino (or other gaming establishment) will consistently lose money to a player that, through luck and/or consistently skillful actions or decisions, accomplishes the goals of the game. While it is acceptable, for a player that consistently accomplishes most or all of the stated goals to win more money (including more than he or she put into the gaming machine) than another player that accomplishes comparatively fewer goals, the game must be designed in such a manner as to guarantee that the winnings over time, for any player, will not cause the casino to lose money. The embodiments shown and described herein allow for the game designer to guarantee that no player, however, lucky, clever, strategic, dexterous or skillful, cannot win more than 100% of his or her wagers over a significantly long period of time and over many iterations of the game. This proposition may be called, in short-hand, the Unacceptably High Payback Rule.

For example, consider the payout schedule in Table 2 below:

TABLE 2

| Payout Amount | Payout | Probability Range |
|---|---|---|
| 2 | 80% | 0 . . . 79 |
| 5 | 12.5% | 80 . . . 89 |
| 20 | 5% | 90 . . . 94 |
| 40 | 2.5% | 96 . . . 99 |

Eighty percent of the time, the scaled or normalized (from 0 to 99) random number will be within the range of 0 to 79, which will cause the player to be rewarded $2. This $2, in the present example, may correspond to 200 movement units. 12.5% of the time, the scaled or normalized random number will be within the range of 80 to 89, which will cause the player to be rewarded $5. This $5, in the present example, may correspond to 500 movement units. Five percent of the time, the scaled or normalized random number will be within the range of 90 to 94, which will cause the player to be rewarded $20. This $20, in the present example, may correspond to 2,000 movement units. Lastly, 2.5% of the time, the scaled or normalized random number will be within the range of 96 to 99, which will cause the player to be rewarded $40. This $40, in the present example, may correspond to 4,000 movement units. According to one embodiment, therefore, the more the player wins, the more his or her virtual avatar 1012 may continue to explore the landscape 1002, expending movement units along the way.

According to one embodiment, different pay schedules may be selected if the player's virtual avatar comes to battle equipped with one or more enhancements, such as armor, health potions, better weapons and the like. In the example being developed herein, the virtual avatar 1012, having previously been to the castle 1008 and was given, won or purchased a suit of armor. A suit of armor comes in handy when battling ill-tempered cave-dwelling dragons, giving the armored virtual avatar 1012 a strategic advantage over an avatar battling the dragon sans armor. This also means that the player had the forethought of equipping him or herself with one or more enhancements before arriving at the cave 1010 and battling the dragon. In fact, the game may be configured such that without having acquired one or more enhancements before engaging the dragon in the cave 1010, the player's virtual avatar 1012 may be summarily killed by the dragon (or suffer some other calamity) and the virtual avatar 1012 re-spawned somewhere else (in one embodiment, a random location) in the landscape 1002, potentially far from the cave 1010, thereby requiring the expenditure of additional movement units to return. The game may also be configured to enable the least advantageous payout schedule, should the player's virtual avatar 1012 arrive at the cave without any armor, weapons or other enhancements. In this manner, players whose virtual avatars 1012 are better equipped may, on average and over many iterations, be awarded more money or other indicia of value, as compared to players whose virtual avatars lack such armor, weapons or other enhancements.

In one embodiment, therefore, if the player's avatar comes to the cave 1010 equipped with one enhancement (a suit of armor, for example), another pay schedule may be selected, with different payouts. In one embodiments, the payouts defined by this pay schedule may be more advantageous to the player than the payout schedule that would have been selected had the player's virtual avatar 1012 engaged the dragon without any such enhancements. For example, consider the payout schedule of Table 3:

TABLE 3

| Payout Amount | Payout | Probability Range |
|---|---|---|
| 5 | 80% | 0 . . . 79 |
| 10 | 12.5% | 80 . . . 89 |
| 30 | 5% | 90 . . . 94 |
| 50 | 2.5% | 96 . . . 99 |

As can be seen, the payouts defined by the payout schedule of Table 2 are greater than the payouts defined by the payout schedule of Table 2. Therefore, the savvy player may decide to expend some of his or her money to move around and explore the landscape 1002, visiting landmarks for potential enhancements before moving to a wager-enabled landmark such as the cave 1010 and its resident dragon. Other methods of rewarding players controlling well-equipped virtual avatars may be devised. In one embodiment, multipliers may be used instead of or in addition to different payout schedules.

In one embodiment and as described above, the reward due to the player, as a result of his or her virtual avatar moving within the landscape 1002 to a wager-enabled landmark, may comprise money. In another embodiment, the reward due to the player may comprise energy units. In one embodiment, energy units may be purchased or awarded to the player and tracked by the regulated gaming machine. As shown at 1016 in FIG. 10 and according to one embodiment, the regulated gaming machine may track both money and energy units. An energy unit, according to one embodiment, may be defined as the cost, to the player, for the player's virtual avatar 1012 to move one movement unit. Money may be converted into energy units and energy units may be converted into money. In one embodiment, some or all of the accepted money may be converted into energy units either automatically or on upon request by the player. In such an implementation, moving one movement unit cost one energy unit. Therefore, as the player's virtual avatar 1012 moves throughout the landscape 1002, the player's energy unit account is decremented one available energy unit for each unit of movement of the virtual avatar 1012 within the computer-generated landscape 1002.

In one embodiment, energy units may be selectively awarded to the player when the player's virtual avatar 1012 reaches a landmark. In another embodiment, energy units may also be selectively awarded to the player when the player's virtual avatar 1012 successfully interacts with an in-game asset at a wager-enabled landmark. For example, upon slaying the dragon in the cave 1010, the player may be rewarded money according to a selected payout schedule and/or may be rewarded a predetermined or dynamically-determined number of energy units. The award of energy units allows enables the virtual avatar to continue moving around the landscape 1002 and, in effect, allows the player to continue playing the game, as the player cannot move without energy units and as movement is an integral part of the game.

As detailed above, the regulated gaming machine, according to one embodiment, may track both the player's money and the energy units available to the player's virtual avatar 1012, as shown at 1016. In one embodiment, as long as the money accepted from the player is not depleted, at least some of the money accepted from the player may be converted to energy units when the number of available energy units drops to or below a predetermined number. If the player has no more money available, the player may be prompted to add additional funds to ensure continued game play. If the player chooses not to add additional money, game play may continue and the player's virtual avatar may continue to move within the landscape 1002 until the available energy units are depleted, whereupon game play may end. However, providing sufficient funds are available for conversion of money into energy units, further movement of the virtual avatar 1012 within the computer-generated landscape 1002 is enabled, thereby enabling game play to continue. Should the game end, the player may be given the opportunity to store the state of the game, which game state may be associated with the player, to enable the player to resume game play at some later time, without loss of continuity in the game's narrative flow.

Note the thick-lined square 1026 in FIG. 10. This square 1026 may delimit the currently active area of the landscape 1002. For example, the virtual avatar 1012 may be always located within the active area of the landscape 1002. Note also the chevrons or arrows 1018, 1020, 1022 and 1024 in FIG. 10. These indicate the four cardinal directions; namely East as shown at 1018, West, as shown at 1020, North as shown at 1022 and South as shown at 1024. These arrows 1018, 1020, 1022 and 1024 point to other areas of the landscape 1002 that may be currently outside of the active area 1026. Indeed, the display of the regulated gaming machine may be configured to only render a portion (the active area 1026) of the computer-generated landscape 1002, such that only some of the plurality of landmarks potentially accessible to the player's virtual avatar 1012 are visible to the player on the display at any given time. In the active area 1026 shown in FIG. 10, three landmarks are visible: the city or village 1006, the castle 1008 and the cave 1010. Indications or hints that other landmarks lie beyond the currently active area 1026 may be shown at the periphery of the active area 1026. For example, as shown in FIG. 10, the hut 1028 appears to be located to the South-East and what looks to be an armory 1030 lies somewhere West of the currently active area 1026.

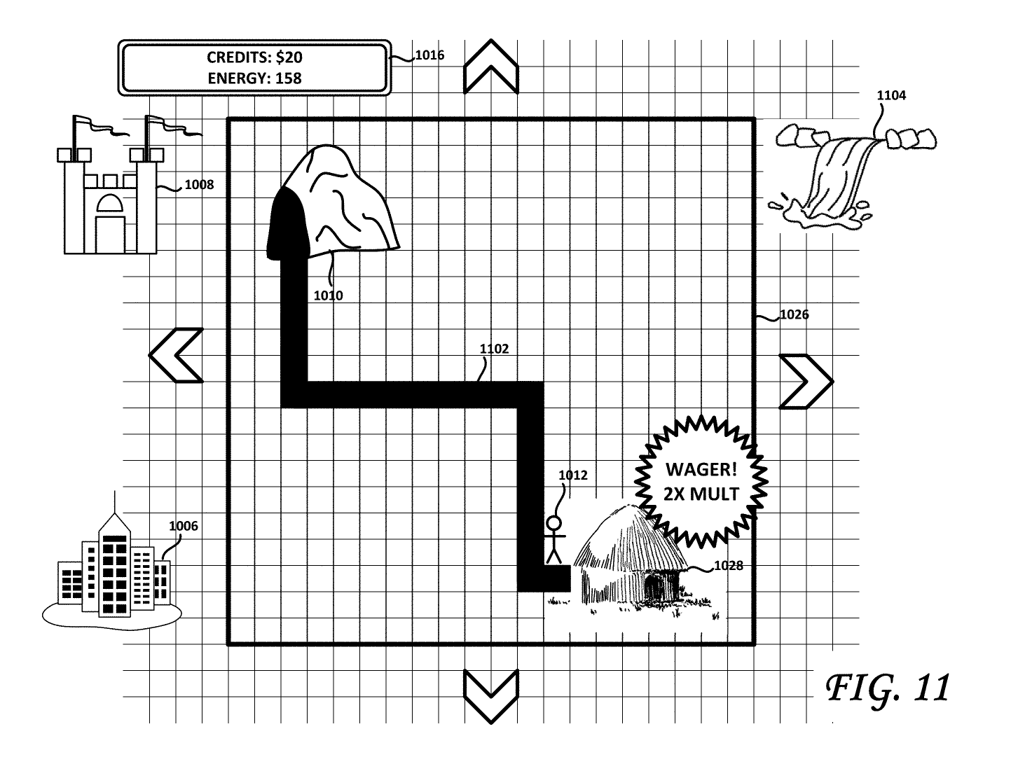

In one embodiment, player inputs may be received by the regulated gaming machine that cause the virtual avatar 1012 to move to an edge of the visible portion (as shown at the thick-lined square 1026 in FIG. 10) of the computer-generated landscape 1002 and cause the landscape to scroll to or otherwise progressively reveal a portion of the landscape not previously rendered on the display of the regulated gaming machine. Supposing now that the player's virtual avatar 1012 had followed the path denoted by 1032 in FIG. 10, the active area 1026 may shift eastward, revealing other topography and landmarks, as shown in FIG. 11. As shown in FIG. 11, the player's virtual avatar 1012 may follow path 1102 from the cave 1010 to the hut 1028, expending one energy unit for each movement unit traversed by his or her virtual avatar 1012. In this example, the virtual avatar 1012 has moved about 42 movement units from the city or village 1006 to the hut 1028. As shown at 1016 in FIG. 11, the number of available energy units, therefore, as decreased by 42, from 200 to 158. Once arrived at the hut 1028, the player may be awarded energy units. Alternatively or in addition, if the hut 1028 is a wager-enabled landmark, a wager may be initiated and the player rewarded according to a predetermined payout schedule or according to a selected one of a plurality of payout schedules. In one embodiment, the nature of the wager may be reduced to the determination of a random amount of money and/or energy units to award the player. As suggested in FIG. 11, arriving at the hut 1028 may qualify the virtual avatar 1012 for a 2x multiplier for this or a next wager. Alternatively still, the hut 1028 may be the home of a shaman who provides the player's avatar with another in-game asset such as a health potion, which in combination with the previously-given armor, may help the player's virtual avatar defeat the next foe, solve the next riddle, successfully accomplish the next task at a yet-to-be-encountered wager-enabled landmark or simply enable a more advantageous payout schedule for this or a next wager. According to one embodiment, now that the player's virtual avatar has both armor and a health potion, the virtual avatar 1012 may successfully accomplish his or her next task, whereas the virtual avatar 1012 may not be successful (or as successful) in his or her next task, had the player's virtual avatar not been equipped with both armor and potion. Alternatively still, being equipped with both armor and a health potion may cause the selection and use of a payout schedule that is more advantageous to the player. Therefore, a player's decision not to equip his or her virtual avatar 1012 with enhancements such as armor and potions may adversely affect the avatar's ability to kill the next monster or accomplish the next task—and/or may thus affect his or her rewards, in terms of money and/or energy units. For example, a more advantageous payout schedule may be selected at the next wager-enabled landmark visited by the player's virtual avatar 1012 and used to determine amounts due to the player.

As shown in FIG. 11, the active area 1026 of the computer-generated landscape no longer includes the castle 1008 or the city or village 1006, which have scrolled outside of the active area 1026. A waterfall 1104 is also shown in FIG. 11, also outside of the active area 1026. The player may decide to move in a general north-easterly direction to scroll to that landmark in search of additional enhancements and/or wager-enabled landmarks.

In one embodiment, any remaining energy units may be converted back to money upon request. For example, if the player is called away from the regulated gaming machine, or wishes to play another game, he or she may request that any remaining energy units be re-converted back into money and his or her resulting money balance credited back. The conversion rate between energy units and money may be one-to-one, or may be some other predetermined exchange rate.

According to one embodiment, the placement of the landmarks may be random, predetermined or procedurally-determined, as may be the initial landing point of the player's virtual avatar 1012 within the computer-generated landscape 1002. In one embodiment, a marker may be placed at a selected location within the computer-generated landscape, which marker allows the player's virtual avatar 1012 to return to the selected location at will, without expending energy units or expending a predetermined set amount of energy units. This may be useful, in that the player's virtual avatar 1012 may place a marker at or near a landmark offering some particular type of enhancement (upgraded weapons, healing powers, etc.) for which the player does not presently need but believes that he or she may need later in the game. The player's virtual avatar may also be offered the ability to earn or pay for faster or cheaper travel, such as enabling the virtual avatar 1012 to mount a virtual horse or grow to become a giant able to traverse greater distances within the computer-generated landscape using fewer movement units. Other modifications are possible.

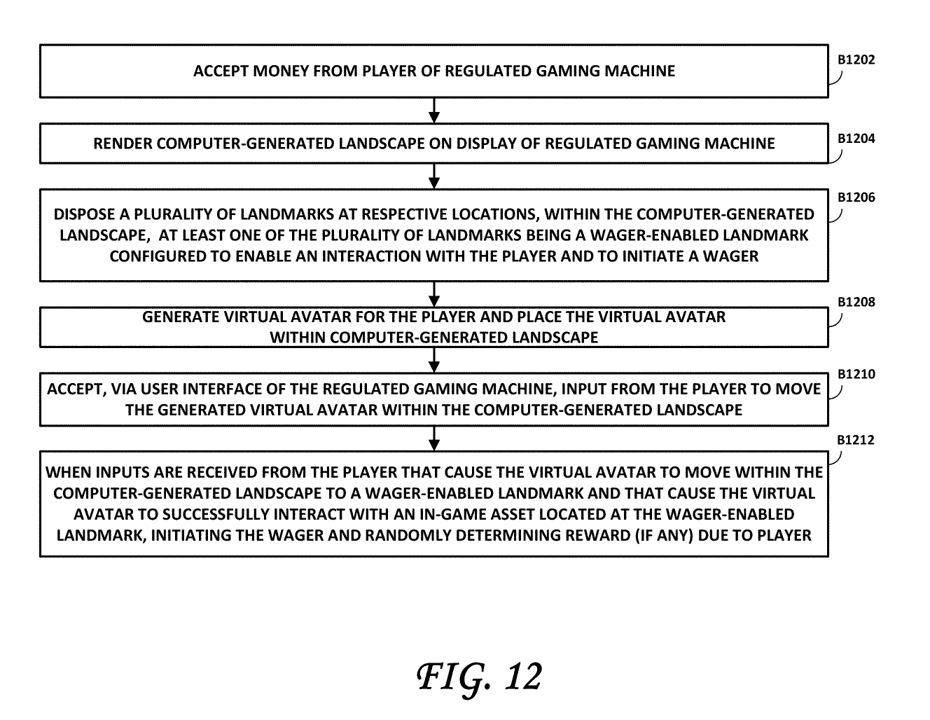

FIG. 12 is a flowchart of a computer-implemented method according to one embodiment. As shown at B1202, the computer-implemented method may include accepting money (in any suitable form) from the player of regulated gaming machine. Block B1204 calls for rendering the computer-generated landscape 1002 on a display of the regulated gaming machine. As noted earlier, the entire landscape 1002 may be pre-generated or the landscape may be procedurally generated on the fly. The landscape may be generated to include topological features, different biomes (desert, jungle, wetlands, etc.) and any other features that contribute to the generation of an environment that engages and encourages the player to continue playing the game. As shown at B1206, a plurality of landmarks may be disposed at respective locations, within the computer-generated landscape. One or more of these landmarks may be wager-enabled landmarks configured to enable an interaction with the player and to initiate a wager. The wager, according to one embodiment, may simply comprise the determination of the amount, if any, to reward the player, both in terms of energy units and money. As shown at B1208, the virtual avatar 1012 may be generated and placed somewhere within the within computer-generated landscape. In block B1210, input from the player may be accepted, via the user interface of the regulated gaming machine, to move the generated virtual avatar within the computer-generated landscape. As shown at B1212, when inputs are received from the player that cause the virtual avatar to move within the computer-generated landscape to a wager-enabled landmark and that cause the virtual avatar to successfully interact with an in-game asset located at the wager-enabled landmark, a wager may be initiated and the reward (if any) due to player may be determined. In one embodiment, the wager may solely comprise a random determination of an award due to the player.

In further embodiments, the reward due to the player may comprise money and/or energy units. At least a portion of the accepted money may be converted into energy units and debiting may comprise decrementing the energy units for each unit of movement of the virtual avatar within the computer-generated landscape. As long as the money accepted from the player is not depleted, at least some of the money accepted from the player may be converted to energy units when the number of the energy units drops to a predetermined number, thereby enabling further movement of the virtual avatar 1012 within the computer-generated landscape 1002. In one embodiment, placing the virtual avatar 1012 within the computer-generated landscape may comprise placing the virtual avatar 1012 at a randomly-determined location within the computer-generated landscape. In other implementations, the virtual avatar 1012 may be placed in a predetermined location or a procedurally-determined location within the computer-generated landscape. In one embodiment, interacting with the in-game asset located at the wager-enabled landmark may comprise the virtual avatar attempting to accomplish a predetermined task. Only a portion of the computer-generated landscape may be rendered on the display of the regulated gaming machine, such that only some of the plurality of landmarks may be visible to the player on the display at any given time. The method may further comprise receiving player inputs that cause the virtual avatar to move to an edge of the visible portion of the computer-generated landscape and cause the landscape to scroll to reveal a portion of the landscape not previously rendered on the display of the regulated gaming machine. In one embodiment, any remaining energy units may be converted back to money upon request. Moreover, in one embodiment, one or more of the plurality of landmarks may comprise an in-game asset (armor, potion, weapon, etc.) that increases a likelihood that the virtual avatar will successfully interact with the in-game asset located at the wager-enabled landmark, and/ or increases the reward due to the player upon interacting with an in-game asset at the wager-enabled landmark.

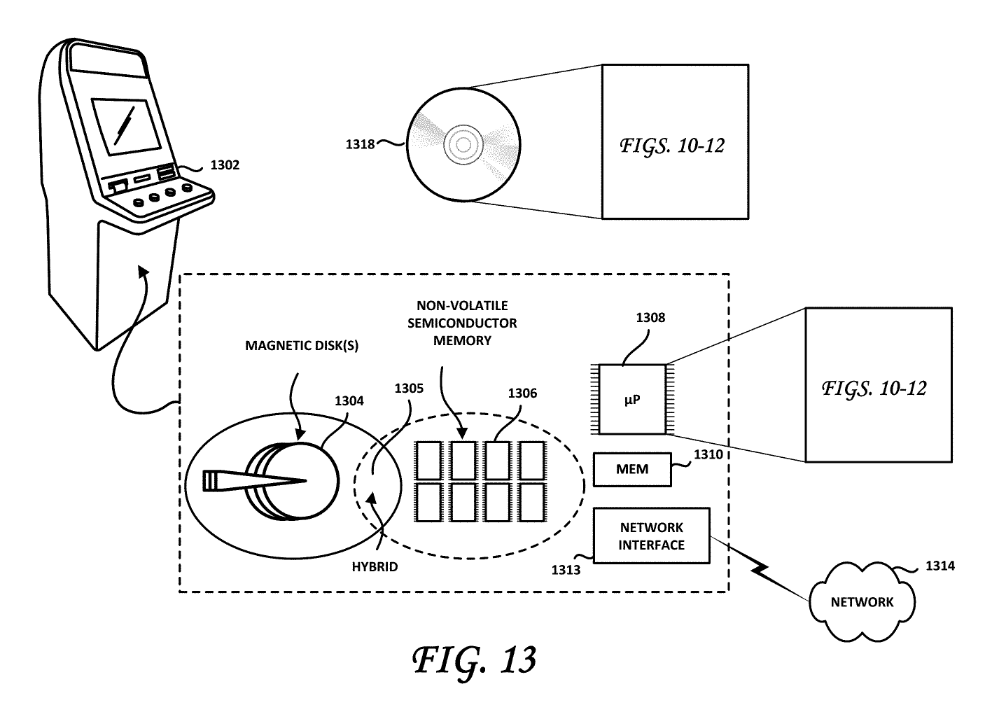

FIG. 13 shows a wager-based regulated gaming machine configured according to embodiments. FIG. 13 also shows exemplary tangible, non-transitory computer-readable media having data stored thereon representing sequences of instructions which, when executed by the regulated gaming computing device, cause the regulated gaming computing device to determine rewards due to a player playing a wager-based game according to embodiments. As shown therein, reference number 1302 is a regulated gaming machine, also referenced herein as an electronic gaming device (EGD) and electronic gaming machine (EGM). The regulated gaming machine 1302 may comprise direct access data storage devices such as magnetic disks 1304, non-volatile semiconductor memories (EEPROM, Flash, etc.) 1306, a hybrid data storage device comprising both magnetic disks 1304 and non-volatile semiconductor memories, as suggested at 1305, one or more microprocessors 1308 and volatile memory 1310. The regulated gaming machine 1302 may also comprise a network interface 1312, configured to communicate over network 1314 with remote servers (not shown in FIG. 13). References 1304, 1305 and 1306 are examples of tangible, non-transitory computer-readable media having data stored thereon representing sequences of instructions which, when executed by a regulated gaming computing device, cause the regulated gaming computing device to implement all or part of the embodiments described and shown herein. Indeed, all or part of the structures and functionality described and shown herein may form part of or may be carried out by one or more remote servers coupled to the EGM or EGD 1302 over the network 1314. In another embodiment, the EGM/EGD 1302 may subscribe to web services to carry out all or part of the functionalities described herein. Some of the machine-readable instructions embodying aspects of embodiments may be stored locally in the gaming machine 1302, while others of these instructions may be stored (and/or executed) remotely and communicated to the gaming machine 1302 over the network 1314. In other embodiments, all of these instructions may be stored locally in the gaming machine 1302, while in still other embodiments, all of these instructions are stored and executed remotely, based on payer interactions at the gaming machine 1302, and the results communicated to the gaming machine 1302. In another embodiment, the instructions may be stored on another form of a tangible, non-transitory computer readable medium, such as shown at 1316. For example, reference 1316 may be implemented as an optical disk, which may constitute one among many suitable data carriers to load the instructions stored thereon onto the gaming machine 1302, thereby physically re-configuring the gaming machine to a regulated gaming machine according to one or more of the embodiments described and shown herein. In other implementations, reference 1316 may be embodied as an encrypted Flash drive. Other implementations are possible.

In FIGS. 10 and 11, the landscape 1002 is shown as a crude plan view of a terrestrial landscape. However, this need not be the case. Indeed, a first-person point-of-view may be provided, from the point of view of the player's virtual avatar 1012. Other landscapes are possible, such as a seascape, with islands and other features to explore interspersed therein. The roguelike landscape may alternatively be interplanetary or interstellar space. In that case, the “movement costs money or energy units” paradigm described herein closely matches reality, where any change of direction, velocity or acceleration does indeed cost money or the fuel equivalent thereof. In the sea and outer space implementations, the game may enable some kind of triangular trade between distantly-separated landmarks (planets, space stations, asteroids and the like), where experienced players may make in-game choices that enable more advantageous, on average, payout schedules. In an implementation in which the landscape 1002 is under the sea, the virtual currency (such as the energy units discussed relative to FIGS. 10 and 11) may consist of units of air and the player's virtual avatar (a diver, for example) may need to periodically refill his or her air tanks (buy more air units) as his or her avatar explores the underwater vistas in search of landmarks and wager-enabled landmarks. Moving underwater may cost the player one unit of air for each unit of time spent underwater or for each unit of underwater movement. Other implementations may be devised by those of skill in this art.

Herein, energy units may be thought of as a virtual currency, the expenditure of which enables the player's virtual avatar to move around the provided landscape 1002. This virtual currency may have a set exchange rate with money and the player may always be given the opportunity to change money into energy units or energy units back into money. Herein, the expenditure of such virtual currency enables the player's virtual avatar to move around the landscape to arrive at wager-enabled landmarks where the player can earn real money, energy units or a combination of real money and energy units. In this manner, through the expenditure of in-game virtual currency, the player can win real-world money while enjoying an interactive, engaging and entertaining exploration game. In one embodiment, energy units (or any other virtual currency) may not be needed to win money. That is, after having arrived at a wager-enabled landmark, the player's reward may be randomly determined without the player's virtual avatar expending any further virtual currency or real money. Herein, for example, after expending energy units arriving at the cave 1010, the player's reward may be randomly determined without further cost to the player. In one embodiment, the player pays not for the actual wager, but for the player's virtual avatar getting to the landmark where the wager (or simply the random determination of the player's reward) may be initiated.

In the foregoing description, numerous specific details are set forth in order to provide a thorough understanding of one or more aspects and/or features of the exemplary embodiments. It will be apparent to one skilled in the art, however, that one or more aspects and/or features described herein may be omitted in favor of others or omitted all together. In some instances, the description of well-known process steps and/or structures are omitted for clarity or for the sake of brevity.

Herein, devices or processes that are described as being in communication with each other need not be in continuous communication with each other, unless expressly specified otherwise. In addition, devices or processes that are disclosed to be in communication with one another may communicate directly or indirectly through one or more intermediaries.

Further, although constituent steps of methods have been described in a sequential order, such methods may be configured to work in alternate orders. In other words, any sequence or order of steps that may be described herein does not, in and of itself, indicate a requirement that the steps be performed in that order. The steps of described processes may be performed in an order that differs from the order described herein. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred over other processes.

When a single device or article is described, it will be readily apparent that more than one device/article (e.g., whether or not they cooperate) may be used in place of a single device/article. Similarly, where more than one device or article is described (e.g., whether or not they cooperate), it will be readily apparent that a single device/article may be used in place of the more than one device or article. The functionality and/or the features of a device may be alternatively embodied by one or more other devices that are not explicitly described as having such functionality/features.

Lastly, while certain embodiments of the disclosure have been described, these embodiments have been presented by way of example only, and are not intended to limit the scope of the disclosure. Indeed, the novel methods, devices and systems described herein may be embodied in a variety of other forms. Furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the actual physical and logical structures may differ from those shown in the figures. Depending on the embodiment, certain steps described in the example above may be removed, others may be added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A computer-implemented method of determining a reward due to a player of a regulated gaming machine, comprising:
accepting money from a player of the regulated gaming machine;
rendering, for the player, a computer-generated landscape on a display of the regulated gaming machine;
disposing a corresponding plurality of landmarks at respective locations, within the computer-generated landscape, at least one of the plurality of landmarks being a wager-enabled landmark that is configured to initiate a wager;
generating a virtual avatar for the player and placing the virtual avatar within the computer-generated landscape;
accepting, via a user interface of the regulated gaming machine, input from the player to move the generated virtual avatar within the computer-generated landscape;
debiting some of the money accepted from the player for each unit of movement of the virtual avatar within the computer-generated landscape;
when inputs are received from the player that cause the virtual avatar to move within the computer-generated landscape to a wager-enabled landmark and that cause the virtual avatar to interact with an in-game asset located at the wager-enabled landmark, initiating the wager and randomly determining the reward due to the player.

2. The computer-implemented method of claim 1, wherein the reward due to the player comprises money.

3. The computer-implemented method of claim 1, further comprising converting at least a portion of the accepted money into energy units and wherein debiting comprises decrementing the energy units for each unit of movement of the virtual avatar within the computer-generated landscape.

4. The computer-implemented method of claim 3, wherein the reward due to the player comprises energy units.

5. The computer-implemented method of claim 3 further comprising, as long as the money accepted from the player is not depleted, converting at least some of the money accepted from the player to energy units when a number of the available energy units drops to a predetermined number, thereby enabling further movement of the virtual avatar within the computer-generated landscape.

6. The computer-implemented method of claim 1, wherein placing the virtual avatar within the computer-generated landscape comprises placing the virtual avatar at a randomly-determined location within the computer-generated landscape.

7. The computer-implemented method of claim 1, wherein interacting with the in-game asset located at the wager-enabled landmark comprises the virtual avatar attempting to accomplish a predetermined task.

8. The computer-implemented method of claim 1, further comprising rendering, on a display of the regulated gaming machine, only a portion of the computer-generated landscape, such that only some of the plurality of landmarks are visible to the player on the display at any given time.

9. The computer-implemented method of claim 8, further comprising receiving player inputs that cause the virtual avatar to move to an edge of the visible portion of the computer-generated landscape and cause the landscape to scroll to reveal a portion of the landscape not previously rendered on the display of the regulated gaming machine.

10. The computer-implemented method of claim 3, further comprising converting any remaining energy units back to money upon request.

11. The computer-implemented method of claim 1, wherein at least one of the plurality of landmarks comprises an in-game asset that at least one of:
increases a likelihood that the virtual avatar will successfully interact with the in-game asset located at the wager-enabled landmark, and
increases the reward due to the player upon interacting with an in-game asset at the wager-enabled landmark.

12. An electronic, wager-based gaming device configured to enable a player to play a game, comprising:
a memory;
a user interface;
a processor coupled to the memory and to the user interface, and
a plurality of processes spawned by the processor, the plurality of processes comprising processing logic to:
accept money from a player of the regulated gaming machine;
render, for the player, a computer-generated landscape on a display of the regulated gaming machine;
disposing a corresponding plurality of landmarks at respective locations, within the computer-generated landscape, at least one of the plurality of landmarks being a wager-enabled landmark that is configured to initiate a wager;
generate a virtual avatar for the player and placing the virtual avatar within the computer-generated landscape;
accept, via a user interface of the regulated gaming machine, input from the player to move the generated virtual avatar within the computer-generated landscape;
debit some of the money accepted from the player for each unit of movement of the virtual avatar within the computer-generated landscape;
when inputs are received from the player that cause the virtual avatar to move within the computer-generated landscape to a wager-enabled landmark and that cause the virtual avatar to interact with an in-game asset located at the wager-enabled landmark, initiate the wager and randomly determine a reward due to the player.

13. The electronic, wager-based gaming device of claim 12, wherein the reward due to the player comprises money.

14. The electronic, wager-based gaming device of claim 12, further comprising processing logic to:
convert at least a portion of the accepted money into energy units, and
decrement the energy units for each unit of movement of the virtual avatar within the computer-generated landscape.

15. The electronic, wager-based gaming device of claim 14, wherein the reward due to the player comprises energy units.

16. The electronic, wager-based gaming device of claim 14 further processing logic to, as long as the money accepted from the player is not depleted, convert at least some of the money accepted from the player to energy units when a number of the energy units drops to a predetermined number, thereby enabling further movement of the virtual avatar within the computer-generated landscape.

17. The electronic, wager-based gaming device of claim 12, wherein the processing logic configured to place the virtual avatar within the computer-generated landscape places the virtual avatar at a randomly-determined location within the computer-generated landscape.

18. The electronic, wager-based gaming device of claim 12, wherein successfully interacting with the in-game asset located at the wager-enabled landmark comprises the virtual avatar successfully accomplishing a predetermined task.

19. The electronic, wager-based gaming device of claim 12, further comprising processing logic render, on the display of the regulated gaming machine, only a portion of the computer-generated landscape, such that only some of the plurality of landmarks are visible to the player on the display at any given time.

20. The electronic, wager-based gaming device of claim 19, further comprising processing logic configured to, upon receiving player inputs that cause the virtual avatar to move to an edge of the visible portion of the computer-generated landscape, cause the landscape to scroll to reveal a portion of the landscape not previously rendered on the display of the regulated gaming machine.

21. The electronic, wager-based gaming device of claim 14, further comprising processing logic to convert any remaining energy units back to money upon request.

22. The electronic, wager-based gaming device of claim 12, wherein at least one of the plurality of landmarks comprises an in-game asset that at least one of:
increases a likelihood that the virtual avatar will successfully interact with the in-game asset located at the wager-enabled landmark, and
increases the reward due to the player upon interacting with an in-game asset at the wager-enabled landmark.
